(19) United States
(12) Patent Application Publication
(10) Pub. No.: US 2010/0079707 A1
(43) Pub. Date: Apr. 1, 2010

(54) CELLULOSE ESTER FILM, AND POLARIZING PLATA AND LIQUID-CRYSTAL DISPLAY DEVICE HAVING THE SAME

(75) Inventors: Hajime NAKAYAMA, Minami-ashigara-shi (JP); Yutaka NOZOE, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/567,240

(22) Filed: Sep. 25, 2009

(30) Foreign Application Priority Data
Sep. 26, 2008 (JP) 2008-248928

(51) Int. Cl. G02F 1/1335; G02B 1/08; C08B 3/00

(52) U.S. Cl. 349/96; 428/220; 428/1.31; 536/58; 359/485

(57) ABSTRACT

The invention relates to a cellulose ester film, comprising at least one cellulose ester that satisfies the following formulae, 2.2≦X₁+X₂≦2.55, 1.1≦X₁<1.5, and 1.05≦X₂≦1.4, which satisfies the following formulae Re(450)/Re(550)<1, Re(650)/Re(550)>1, Rth(450)/Rth(550)<1, and Rth(650)/Rth(550)>1, wherein X₁ means a degree of substitution with an acetyl group in the cellulose ester; X₂ means a degree of substitution with a propionyl group and/or a butyryl group in the cellulose ester; Re(λ) means retardation (nm) in plane of the film at a wavelength of λ (nm); and Rth(λ) means retardation (nm) along the thickness direction of the film at a wavelength of λ (nm).

### CROSS-REFERENCE TO RELATED APPLICATIONS

This application claims benefit of priority under 35 U.S.C. 119 to Japanese Patent Application No. 2008-248928, filed on Sep. 26, 2008, which is expressly incorporated herein by reference in its entirety.

### BACKGROUND OF THE INVENTION

1. Technical Field

The present invention relates to a cellulose ester film, and a polarizing plate and a liquid-crystal display device comprising the film, and especially to a VA (vertical aligned)-mode liquid-crystal display device.

2. Background Art

Recently, the display performance level of liquid-crystal display devices is increasing year by year, and in particular, it is known that, in VA-mode liquid-crystal display devices that are potent as liquid-crystal display devices for large-panel TVs, two polarizing plates are disposed on the display side and on the backlight side of the liquid-crystal cell so that their absorption axes are perpendicular to each other and a biaxial retardation film is disposed between each, polarizing plate and the liquid-crystal cell, whereby the viewing angle of the devices can be widened, or that is, the display characteristics thereof can be improved (e.g., Japanese Patent No. 3330574).

As a better display performance of a liquid-crystal display device, it is desired that the device achieves a high contrast, which is defined as a ratio of (brightness in the white state)/(brightness in the back state), in any directions; and that the color shift observed in the device is small. For achieving these objects, optically biaxial retardation films, having desired optical characteristics, concretely having desired retardation Re (nm) and desired Rth (nm) each falling within a desired range, are required. On the other hand, for increasing the contrast ratio, the transparency of the retardation film is an important factor, and concretely, the haze value of the film is preferably smaller. Further, it is also important that the retardation film has reversed wavelength dispersion characteristics of Re and Rth. This means that Re and Rth of the retardation film decrease lower at a shorter wavelength of the incident light (visible light) running into it.

U.S. Pat. No. 6,503,581 B1 discloses a retardation film, for which not a cellulose acetate having an acetyl group alone as the acyl substituent in a cellulose ester but a cellulose acetate propionate having both an acetyl group and a propionyl group is used thereby making the film have desired Re and Rth. In particular, the reference says that the total degree of substitution, or that is, the total of the degree of acetyl substitution and the degree of propionyl substitution is equal to or less than 2.8.

### SUMMARY OF THE INVENTION

An object of the present invention is to realize a high contrast and to reduce the color shift for further improving the above-mentioned display performance of liquid-crystal display devices. Concretely, one object of the invention is to provide a cellulose ester film capable of contributing toward increasing the contrast of liquid-crystal display devices and reducing the color shift thereof, and to provide a polarizing plate comprising the cellulose ester film, and also to provide a liquid-crystal display device having a high contrast and free from a problem of color shift.

The present inventors have assiduously studied and, as a result, have found that, by using a cellulose ester, having a desired degree of substitution, and a compound, wherein the polarizability anisotropy in the direction of the short axis of each molecule thereof is larger than that in the direction of the long axis, and each molecule thereof is aligned so that its long axis is along the main chain of the cellulose ester in a cellulose ester film, it is possible to provide a cellulose ester film of which the reversed wavelength dispersion characteristics of Re and Rth are enhanced and which is useful for optical compensation, especially for color compensation in VA-mode liquid-crystal display devices.

More concretely, as a result of assiduous studies we made, the present inventors have found that, when a cellulose ester having both an acetyl group and a propionyl group and/or a butyryl group and having a predetermined degree of acetyl substitution, a predetermined degree of propionyl and/or butyryl substitution and a predetermined total degree of substitution is used, then a cellulose ester film having a low haze and having desired characteristics of Re and Rth can be produced, and have further found that, when the cellulose ester film is stretched so as to align the main chain of the cellulose ester in a predirection and when the film contains a compound of which the long axis aligns in that direction, then the cellulose ester film can have reversed wavelength dispersion characteristics of Re and Rth. On the basis of these findings, the inventors have further studied and have completed the present invention.

The means for achieving the object are as follows.
[1] A cellulose ester film, comprising at least one cellulose ester that satisfies the following formulae I to Ill, which satisfies the following formulae IV to VII:

2.2≦X₁+X₂≦2.55, I

1.1≦X₁≦1.5, II

1.05≦X₂≦1.4, III

Re(450)/Re(550)<1, IV

Re(650)/Re(550)>1, V

Rth(450)/Rth(550)<1, VI

Rth(650)/Rth(550)>1, VII

wherein X₁ means a degree of substitution with an acetyl group in the cellulose ester; X₂ means a degree of substitution with a propionyl group and/or a butyryl group in the cellulose ester; Re(λ) means retardation (nm) in plane of the film at a wavelength of λ (nm); and Rth(λ) means retardation (nm) along the thickness direction of the film at a wavelength of λ (nm).
[2] The cellulose ester film of [1], wherein said at least one cellulose ester satisfies the following formulae I′ to III′, and the film satisfies the following formulae VIII and IX:

2.3≦X₁+X₂≦2.5, I′

1.2≦X₁≦1.4 II′

1.1≦X₂≦1.3. III′

5 nm≦{Re(650)−Re(450)}≦20 nm, VIII

10 nm≦{Rth(650)−Rth(450)}≦30 nm. IX
[3] The cellulose ester film of [1] or [2], which satisfies the following formulae X and XI:

40 nm≦Re(589)≦70 nm, X

90 nm≦Rth(589)≦220 nm. XI
[4] The cellulose ester film of any one of [1] to[3], comprising a compound in an amount of from 0.1 to 30% by mass with respect to the amount of the cellulose ester, wherein the polarizability anisotropy in the direction of the short axis of each molecule of the compound is larger than that in the direction of the long axis; and each molecule of the compound aligns so that its long axis is along the main chain of the cellulose ester in a cellulose ester film.
[5] The cellulose ester film of any one of [4], wherein the compound is a compound represented by formula (1):

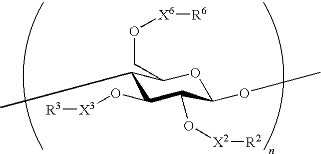

where R², R³ and R⁶ each independently represent a hydrogen atom, aliphatic group or aromatic group; X², X³ and X⁶ each independently represent a single bond or a divalent linking group selected from the group consisting of —O—, —CO—, —NR— (where R represents an aliphatic or aromatic group) and any combinations thereof; and n is a natural number of from 6 to 50.
[6] The cellulose ester film of [4], wherein the compound is a compound represented by formula (A):

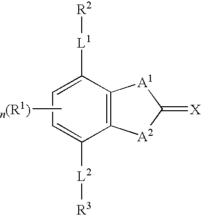

where L¹ and L² each independently represent a single bond or a divalent linking group; A^{l} and A² each independently represent a group selected from the group consisting of —O—, —NR— where R represents a hydrogen atom or a substituent, —S— and —CO—;R¹, R² and R³ independently represent a substituent; X represents a nonmetal atom selected from the groups 14-16 atoms, provided that X may bind with at least one hydrogen atom or substituent; and n is an integer from 0 to 2.
[7] The cellulose ester film of any one of [1] to [6], of which haze is equal to or less than 0.5%.
[8] The cellulose ester film of any one of [1] to [7], wherein the axial misalignment of the slow axis is equal to or less than 0.4 degrees in the overall width of the film.
[9] The cellulose ester film of any one of [1] to [8], which has a thickness of from 20 to 80 μm.
[10] A polarizing plate comprising a cellulose ester film of any one of [1] to [9].
[11] A liquid-crystal display device comprising a polarizing plate of [10].
[12] The liquid-crystal display device of [11], wherein each one polarizing plate of claim 10 is disposed on both the panel side and the backlight side of a VA-mode liquid-crystal so that the absorption axes of the polarizing plates are perpendicular to each other.

According to the invention, it is possible to realize a high contrast and to reduce the color shift for further improving the above-mentioned display performance of liquid-crystal display devices. Concretely, according to the invention, it is possible to provide a cellulose ester film capable of contributing toward increasing the contrast of liquid-crystal display devices and reducing the color shift thereof, and to provide a polarizing plate comprising the cellulose ester film, and also to provide a liquid-crystal display device having a high contrast and free from a problem of color shift. dr

### BRIEF DESCRIPTION OF THE DRAWINGS

FIG. 1 is a schematic view showing a constitution of one example of a liquid-crystal display device of the invention.

The meanings of the reference numerals and signs in the drawing are as follows:
1 Upper substrate of liquid-crystal cell
3 Lower substrate of liquid-crystal cell
5 Liquid-crystal layer (liquid-crystal molecules)
8a, 8b Polarizing film
9a, 9b Absorption axis of polarizing film
10a, 10b Retardation film (cellulose ester film of the invention)
P1, P2 Polarizing plate
LC Liquid-crystal cell

### DETAILED DESCRIPTION OF THE INVENTION

The invention is described in detail hereinunder. Note that, in this patent specification, any numerical expressions in a style of “ . . . to . . . ” will be used to indicate a range including the lower and upper limits represented by the numerals given before and after “to”, respectively.

In this description, Re(λ) and Rth(λ) are retardation in plane (nm) and retardation along the thickness direction (nm), respectively, at a wavelength of λ. Re(λ) is measured by applying light having a wavelength of λ nm to a sample such as a film in the normal direction thereof, using KOBRA 21ADH or WR (by Oji Scientific Instruments).

When a sample to be analyze by a monoaxial or biaxial index ellipsoid, Rth(λ) of the film is calculated as follows. The selectivity of the measurement wavelength λ nm may be conducted by a manual exchange of a wavelength-filter, a program conversion of a measurement wavelength value or the like.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an tilt axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain tilt angle, around the in-plane slow axis from the normal direction as the rotation axis, then the retardation value at the tilt angle larger than the tilt angle to give a zero retardation is changed to negative data, and then the Rth(λ) of the film is calculated by KOBRA 21ADH or WR.

Around the slow axis as the tilt angle (rotation angle) of the film (when the film does not have a slow axis, then its rotation axis may be in any in-plane direction of the film), the retardation values are measured in any desired tilted two directions, and based on the data, and the estimated value of the mean refractive index and the inputted film thickness value, Rth may be calculated according to the following formulae (X) and (XI):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2} +\end{matrix}}} ] \times \frac{d}{cos \{ {sin}^{- 1} ( \frac{sin ( - θ )}{nx} ) \}} & ( X ) \\ Rth = ( \frac{nx + ny}{2} - nz ) \times d & ( XI )\end{matrix}$$

wherein Re(θ) represents a retardation value in the direction tilted by an angle 0 from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the sample such as a film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane tilt axis (rotation axis), relative to the normal direction of the film from −50 degrees up to +50 degrees at intervals of 10 degrees, in 11 points in all with a light having a wavelength of λ, nm applied in the tilted direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some major optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

In the invention, “slow axis” of retardation films and others means the direction in which the refractive index is the largest. “Visible light region” means from 380 nm to 780 nm. Unless otherwise specifically indicated, the refractive index is one measured at λ=589 nm in the visible light region.

In this description, the numerical data, the numerical range and the qualitative expression (for example, “equivalent”, “same”, etc.) indicating the optical properties of constitutive components such as retardation film, liquid-crystal layer and others should be so interpreted as to indicate the numerical data, the numerical range and the qualitative expression that include the error range generally acceptable for liquid-crystal display devices and their constitutive components.

### 1. Cellulose Ester Film:

The invention relates to a cellulose ester film comprising at least a cellulose ester having an acetyl group and a propionyl group and/or a butyryl group. The cellulose ester film of the invention contains at least one cellulose ester that satisfies the following formulae I to III.

2.2≦X₁+X₂≦2.55, I

1.1≦X₁≦1.5, II

1.05≦X₂≦1.4. III

In the formulae, X₁ means a degree of substitution with an acetyl group in the cellulose ester; X₂ means a degree of substitution with a propionyl group and/or a butyryl group in the cellulose ester.

In the invention, a cellulose ester satisfying the above formulae I to III is used, therefore providing a cellulose ester film satisfying the following formulae IV to VII:

Re(450)/Re(550)<1, IV

Re(650)/Re(550)>1, V

Rth(450)/Rth(550)<1, VI

Rth(650)/Rth(550)>1. VII

When a cellulose ester not satisfying the formula I, or that is, a cellulose ester of which X₁+X₂ is less than 2.2 is used, then its hydrophilicity is high and the film thereof is therefore unstable at an ordinary humidity; but on the other hand, when a cellulose ester of which X₁+X₂ is more than 2.55 is used, then retardation to be developed by the alignment of the main chain of the cellulose ester may be canceled by retardation to be developed by the alignment in the perpendicular direction of the side chain component having a high total degree of substitution, and therefore, resulting retardation Re is difficult to increase. The same shall apply to the formula II. When a cellulose ester of which X₁ does not satisfy the formula II, or that is, a cellulose ester of which X₁ is less than 1.1 is used, then its hydrophilicity is high and the film thereof is therefore unstable at an ordinary humidity; but on the other hand, when a cellulose ester of which X₁ is more than 1.5 is used, then Re is difficult to increase. When a cellulose ester of which X₂ does not satisfy the formula III, for example, a cellulose ester of which X₂ is less than 1.05 is used, then it is more hydrophobic since the propionyl group or the butyryl group has more carbon atoms than the acetyl group, and the ester could not sufficiently contribute toward the stability of the film at an increased humidity; but on the other hand, when a cellulose ester of which X₂ is more than 1.4 is used, the desired optical characteristics (Re, Rth) of the film could hardly be developed. In addition, a cellulose ester of which X₂ is more than 1.4 is difficult to produce inexpensively, and using the ester of the type is disadvantageous in point of the production cost in industrial-scale film production.

The optical characteristics satisfying the above formulae IV to VII are reversed wavelength dispersion characteristics of retardation, and this means that Re and Rth are lower at a shorter wavelength of the incident light (visible light) running into the film. The cellulose ester film satisfying the above formulae IV to VII are useful in optical compensation in VA-mode liquid-crystal display devices. In particular, the cellulose ester film satisfying the following formulae VIII and IX is preferable for optical compensation in VA-mode liquid-crystal display devices.

5 nm≦{Re(650)−Re(450)}≦₂₀ nm, VIII

10 nm≦{Rth(650)−Rth(450)}≦30 nm. IX

For producing the cellulose ester film satisfying the above formulae VIII and IX, preferably used is a cellulose ester satisfying the following formulae I′ to III′:

2.3≦X₁+X₂2.5, I′

1.2≦X₁≦1.4, II′

1.1≦X₂≦1.3. III′

The degree of acetyl substitution and the degree of propionyl substitution in a cellulose ester each mean the degree of acetylation and the degree of propionylation and/or butyrylation, respectively, of the three hydroxyl groups existing in the constitutive unit ((β)-1,4-glycoside bonding glucose) in cellulose. In this description, the degree of substitution with an acetyl group, a propionyl group and a butyryl group in a cellulose ester may be computed by measuring the amount of the bonding fatty acid per the constitutive unit mass of cellulose. The measurement may be attained according to “ASTM D817-91”.

### 1.-1 Cellulose Ester:

The cellulose ester film of the invention comprises one or more cellulose esters as the main ingredient thereof. The wording “as the main ingredient” as referred to herein means as follows: When the cellulose ester film comprises one cellulose ester as the material thereof, the main ingredient is that one cellulose ester; and when the film comprises plural types of cellulose esters, then the cellulose ester having the highest mass fraction of those plural cellulose esters is the main ingredient. Cellulose has free hydroxyl groups at the 2-, 3- and 6-positions per the β-1,4-bonding glucose unit therein. As the material of the cellulose ester film of the invention, used is at least a cellulose ester in which these three hydroxyl groups are substituted with an acetyl group and with a propionyl group and/or a butyryl group. Concretely, preferred for use herein is cellulose acetate propionate, cellulose acetate butyrate, or cellulose acetate propionate butyrate.

The cellulose material for cellulose ester includes cotton liter and wood pulp (hardwood pulp, softwood pulp), and cellulose esters obtained from any such cellulose material are usable herein. Those cellulose materials may be mixed for use herein. The cellulose materials are described in detail, for example, in Marusawa & Uda's “Plastic Material Lecture (17), Cellulose Resin” by Nikkan Kogyo Shinbun (1970) and Hatsumei Kyokai's Disclosure Bulletin 2001-1745 (pp. 7-8), and those celluloses described therein may be usable herein. There should not be any specific limitation to the cellulose ester film for use in the invention.

Preferably, the cellulose ester has a mass-average degree of polymerization of from 350 to 800, more preferably from 370 to 600. Also preferably, the cellulose ester for use in the invention has a number-average molecular weight of from 70000 to 230000, more preferably from 75000 to 230000, even more preferably from 78000 to 120000.

The cellulose ester may be produced, using an acid anhydride or an acid chloride as the acylating agent for it. One most general production method for producing the cellulose ester on an industrial scale comprises esterifying cellulose obtained from cotton linter, wood pulp or the like with a mixed organic acid component comprising an organic acid corresponding to an acetyl group and propionyl and/or butyryl group, that is, acetic acid and propionic and and/or butyric acid, or its acid anhydride, that is, acetic anhydride and propionic anhydride and/or butyric anhydride.

### 1.-2 Additive:

The cellulose ester film of the invention may contain at least one additive for various purposes. When the cellulose ester film is produced according to a solvent-casting method, the additive may be added to a cellulose ester dope. The timing of addition is not specifically defined. The additive is selected from those miscible with cellulose ester (soluble in a cellulose ester dope in a solvent-casting method). The additive is added for the purpose of controlling the optical properties of cellulose ester and for controlling other properties thereof.

In the invention, additive to the cellulose ester film is preferably selected from the compounds wherein the polarizability anisotropy in the direction along the short axis of each molecule thereof is larger than that in the direction of the long axis, and molecules thereof aligns so that their long axis are along the main chain of the cellulose ester in the cellulose ester film. When the compound having the above-mentioned characteristics is added to the cellulose ester film, then it is preferable since it enhances the reversed wavelength dispersion characteristics of Re and Rth of the cellulose ester film. Preferably, the amount of the compound having the above-mentioned characteristics to be added to the film is from 0.1 to 30% by mass of the amount of the cellulose ester to be used along with the additive, more preferably from 1 to 30% by mass, even more preferably from 2 to 30% by mass, still more preferably from 2 to 25% by mass, further more preferably from 2 to 20% by mass.

Examples of the compound having the above mentioned characteristics include the group represented by formula (I) and the group represented by formula (A).

Compound represented by formula (I):

Examples of the compound, having the above-mentioned characteristics, include the group represented by formula (1).

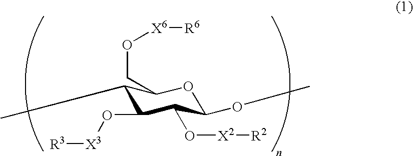

In formula (1), R², R³ and R⁶ each independently represent a hydrogen atom, aliphatic group or aromatic group. The combination of R², R³ and R⁶ is preferably the binary system of “a hydrogen atom/an aromatic group” and the ternary system of “a hydrogen atom/an aliphatic group/an aromatic group”, however, there is no limitation on the combination of R², R³ and R⁶. The aliphatic group may be any linear, branched and cyclic aliphatic group. The aliphatic or aromatic group may have one or more substituents, and examples of the substituent include Substituent Group T described below. X², X³ and X⁶ each independently represent a single bond or a divalent linking group selected from the group consisting of —O—, —CO—, —NR—, where R represents an aliphatic or aromatic group, and any combinations thereof. Preferably, X², X³ and X⁶ each independently represent —CO— or —NR—, however, there is no limitation on the combination of X², X³ and X⁶. In formula (1), n is a natural number of from 6 to 50. Preferably, n is from 7 to 50; more preferably, n is from 7 to 40; and much more preferably, n is from 7 to 40.

The groups, connecting to the both terminals of the unit represented by formula (1), are not limited, and the usual terminal atom or group such as a hydrogen atom or low-alkyl group, aliphatic acyl group and aromatic acyl group may connect to the terminals.

The aliphatic group may be linear, branched or cyclic, and is preferably a C₁₋₁₂ aliphatic group, more preferably C₁₋₈ aliphatic group and even more preferably C₁₋₅ aliphatic group. Examples of the aliphatic group include methyl, ethyl, n-propyl, iso-propyl, cyclopropyl, n-butyl, iso-butyl, sec-butyl, tert-butyl, amyl, iso-amyl, tet-amyl, n-hexyl, cyclohexyl, n-heptyl, n-octyl, bicyclooctyl, adamantly, n-decyl, tert-octyl and dodecyl.

The aromatic group may be an aromatic hydrocarbon group or aromatic heterocyclic group, and is preferably an aromatic hydrocarbon group. The aromatic hydrocarbon group is preferably a C₆₋₂₄ aromatic hydrocarbon group, and more preferably a C₆₋₁₂ aromatic hydrocarbon group. Examples of the aromatic ring of the aromatic hydrocarbon group include benzene, naphthalene, anthracene, biphenyl and terphenyl. Benzene, naphthalene and biphenyl are preferable. An aromatic heterocyclic group preferably has at least one selected from the group consisting of an oxygen, nitrogen and sulfur atoms. Examples of the hereto-ring include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthylidine, quinoxaline, quinazoline, cinnoline, pteridine, acridine, phenanthrene, phenazine, tetrazole, benzimidazole, benzoxazole, benzthiazole, benzotriazole and tetrazaindene. Pyridine, triazine and quinoline are preferable.

Substitution Group T: Alkyls (preferably C₁₋₂₀, more preferably C₁₋₁₂ and much more preferably C₁₋₈ alkyls) such as methyl, ethyl, isopropyl, ter-butyl, n-octyl, n-decyl, n-hexadecyl, cyclopropyl, cyclopentyl and cyclohexyl; alkenyls (preferably C₂₋₂₀, more preferably C₂₋₁₂ and much more preferably C₂₋₈ alkenyls) such as vinyl, allyl, 2-butenyl and 3-pentenyl; alkynyls (preferably C₂₋₂₀, more preferably C₂₋₁₂ and much more preferably C₂₋₈ alkynyls) such as propargyl and 3-pentynyl; aryls (preferably C₆₋₃₀, more preferably C₆₋₂₀ and much more preferably C₆₋₁₂ aryls) such as phenyl, biphenyl and naphthyl; aminos (preferably C₀₋₂₀, more preferably Cₒ₋₁₀ and much more preferably Cₒ₋₆ aminos) such as amino, methylamino, dimethylamino, diethylamino and dibenzylamini; alkoxys (preferably C₁₋₂₀, more preferably C₁₋₁₂ and much more preferably C₁₋₈ alkoxys) such as methoxy, ethoxy and butoxy; aryloxys (preferably C₆₋₁₀, more preferably C₆₋₁₆ and much more preferably C₆₋₁₂ aryloxys) such as phenyloxy and 2-naphthyloxy; acyls (preferably C₁₋₂₀, more preferably C₁₋₁₆ and much more preferably C₁₋₁₂ acyls) such as acetyl, benzoyl, formyl and pivaloyl; alkoxycarbonyls (preferably C₂₋₂₀, more preferably C₂₋₁₆ and much more preferably C₂₋₁₂ alkoxycarbonyls) such as methoxycarbonyl and ethoxycarbonyl; aryloxycarbonyls (preferably C₇₋₂₀, more preferably C₇₋₁₆ and much more preferably C₇₋₁₀ aryloxycarbonyls) such as phenyloxycarbonyl; acyloxys (preferably C₂₋₂₀, more preferably C₂₋₁₆ and much more preferably C₂₋₁₀ acyloxys) such as acetoxy and benzoyloxy; acylaminos (preferably C₂₋₂₀, more preferably C₂₋₁₆ and much more preferably C₂₋₁₀ acylaminos) such as acetylamino and benzoylamino; alkoxycarbonylaminos (preferably C₂₋₂₀, more preferably C₂₋₁₆ and much more preferably C₂₋₁₂ alkoxycarbonylaminos) such as methoxycarbonylamino; aryloxycarbonylaminos (preferably C₇₋₂₀, more preferably C₇₋₁₆ and much more preferably C₇₋₁₂ aryloxycarbonylaminos) such as phenoxycarbonylamino; sulfonylaminos (preferably C₁₋₂₀, more preferably C₁₋₁₆ and much more preferably C₁₋₁₂ sulfonylaminos) such as methane sulfonylamino and benzene sulfonylamino; sulfamoyls (preferably C₀₋₂₀, more preferably C₀₋₁₆ and much more preferably C₀₋₁₂ sulfamoyls) such as sulfamoyl, methyl sulfamoyl, dimethyl sulfamoyl and phenyl sulfamoyl; carbamoyls (preferably C₁₋₂₀, more preferably C₁₋₁₆ and much more preferably C₁₋₁₂ carbamoyls) such as carbamoyl, methyl carbamoyl, diethyl carbamoyl and phenyl carbamoyl; alkylthios (preferably C₁₋₂₀, more preferably C₁₋₁₆ and much more preferably C₁₋₁₂ alkylthios) such as methylthio and ethylthio; arylthios (preferably C₆₋₂₀, more preferably C₆₋₁₆ and much more preferably C₆₋₁₂ arylthios) such as phenylthio; sulfonyls (preferably C₁₋₂₀, more preferably C₁₋₁₆ and much more preferably C₁₋₁₂ sulfonyls) such as mesyl and tosyl; sulfinyls (preferably C₁₋₂₀, more preferably C₁₋₁₆ and much more preferably C₁₋₁₂ sulfinyls) such as methane sulfinyl and benzene sulfinyl; ureidos (preferably C₁₋₂₀, more preferably C₁₋₁₆ and much more preferably C₁₋₁₂ ureidos) such as ureido, methylureido and phenylureido; amide phosphate group (preferably C₁₋₂₀, more preferably C₁₋₁₆ and much more preferably C₁₋₁₂ amide phosphate group) such as amide diethyl phosphate and amide phenyl phosphate; hydroxy; mercapto; halogen atoms such as fluorine atom, chlorine atom, bromine atom and iodine atom; cyano; sulfo; carboxyl; nitro; hydroxamic group; sulfino; hydrazine; imino; heterocyclic group (preferably C₁₋₃₀ and more preferably C₁₋₁₂ heterocyclic group having at least one hetero atom such as nitrogen, oxygen or sulfur atom) such as imidazolyl, pyridyl, quinolyl, furyl, piperidyl, morpholino, benzoxazole, benzoimidazolyl and benzothiazolyl; and silyl group (preferably C₃₋₄₀, more preferable C₃₋₃₀ and much more preferably C₃₋₂₄ silyl group) such as trimethyl silyl and triphenyl silyl. These substituents may have at least one substituent selected from Substitution Group T. If there are plural substituents, they may be same or different from each other. If possible, two or more may form a ring.

In the repeating unit represented by formula (1), the 2-, 3- or 6-position position hydroxy(s) in the β-1,4-bonding glucose unit at least partially form an ester bond with carboxylic acid (indicates both of any aliphatic carboxylic acids and any aromatic carboxylic acids). The total substitution degree with the acyl group in the glucose unit is preferably from 2.0 to 3.0, more preferably from 2.4 to 3.0, and even more preferably from 2.6 to 2.95.

The compound represented by formula (1) contains from 6 to 50 of the repeating units therein, and the compound is so-called oligomer. The groups, connecting to the both terminals of the unit represented by formula (1), are not limited, and the usual terminal atom or group such as a hydrogen atom or low-alkyl group, aliphatic acyl group and aromatic acyl group may connect to the terminals.

Preferable examples of the oligomer compound represented by formula (1) include, but are not limited to, those shown below. In the table, the partial moieties, R corresponding to —X²—R², —X³—R³ or —X⁶—R⁶, and the degrees of the substitution of the examples are shown. Regarding the examples shown below, the number in the term “Substitution 1” or “Substituent 2” is used for identifying the substitution, R, introduced into the 2-, 3- or 6-position.

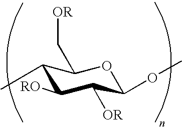

| | R | | | Degree of |
|---|---|---|---|---|
| | | Degree | Total degree of | Polymerization |
| Example | Substitution 1 | Substitution | Substitution | n |
| A3 | 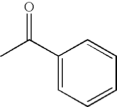 | 2.6 | 2.6 | 40 |
| A4 | 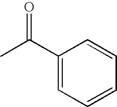 | 2.0 | 2.0 | 40 |
| A5 | 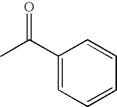 | 2.6 | 2.6 | 30 |
| A6 | 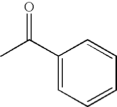 | 2.0 | 2.0 | 30 |
| A7 | 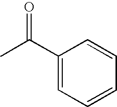 | 2.9 | 2.9 | 15 |
| A8 | 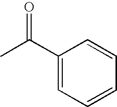 | 2.9 | 2.9 | 7 |
| A9 | 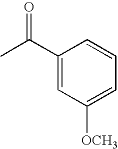 | 2.5 | 2.5 | 40 |
| A10 | 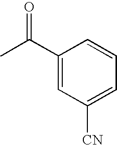 | 2.4 | 2.4 | 40 |
| A11 | 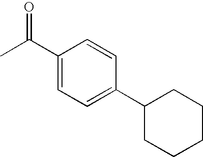 | 2.5 | 2.5 | 40 |
| A12 | 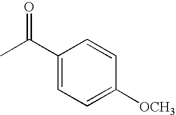 | 2.5 | 2.5 | 40 |
| A13 | 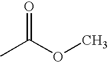 | 2.8 | 2.8 | 15 |
| A14 | 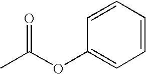 | 2.8 | 2.8 | 15 |
| A15 | 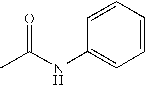 | 3.0 | 3.0 | 15 |
| A16 | 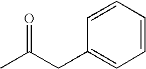 | 2.6 | 2.6 | 15 |
| A18 | 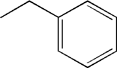 | 2.5 | 2.5 | 15 |

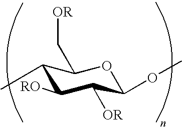

| | R | | | | Total | Degree |
|---|---|---|---|---|---|---|
| | Substitution | Degree of | | Degree of | Degree of | Polymerization |
| Example | 1 | Substitution | Substitution 2 | Substitution | Substitution | n |
| B1 | 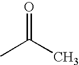 | 2.6 | 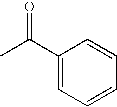 | 0.2 | 2.8 | 40 |
| B2 | 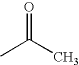 | 2.0 | 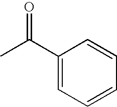 | 0.8 | 2.8 | 30 |
| B3 | 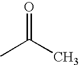 | 2.6 | 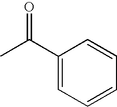 | 0.4 | 3.0 | 40 |
| B4 | 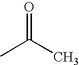 | 2.0 | 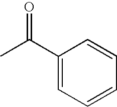 | 1.0 | 3.0 | 30 |
| B5 | 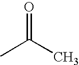 | 2.0 | 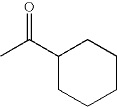 | 1.0 | 3.0 | 30 |
| B6 | 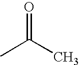 | 2.0 | 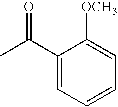 | 0.4 | 2.4 | 30 |
| B7 | 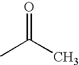 | 2.0 | 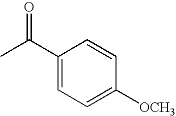 | 0.4 | 2.4 | 30 |
| B8 | 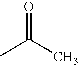 | 2.0 | 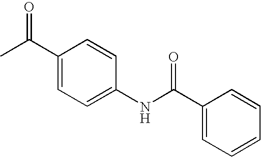 | 0.5 | 2.5 | 30 |
| B9 | 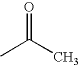 | 2.0 | 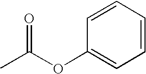 | 0.8 | 2.8 | 30 |
| B10 | 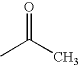 | 2.0 | 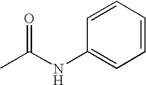 | 1.0 | 3.0 | 30 |
| B11 | 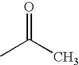 | 2.0 | 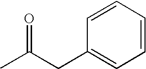 | 0.8 | 2.8 | 30 |
| B12 | 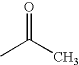 | 1.5 | 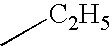 | 1.5 | 3.0 | 7 |
| B13 | 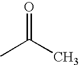 | 1.6 | 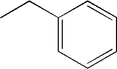 | 1.2 | 3.0 | 7 |

The oligomer compound represented by formula (1) may be prepared according to any process using cellulose oligomer or cellulose acylate oligomer as a raw material.

Compound represented by formula (A):

The cellulose ester film preferably contains the compound represented by formula (A). By adding the compound represented by formula (A) to the film, retardation in plane may be increased, and reversed wavelength dispersion characteristics of retardation may be developed.

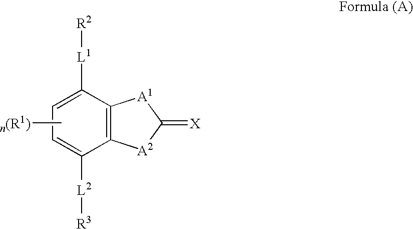

In the formula, L¹ and L² independently represent a single bond or a divalent linking group; A^{l} and A² independently represent a group selected from the group consisting of —O—, —NR— where R represents a hydrogen atom or a substituent, —S— and —CO—;R¹, R² and R³ independently represent a substituent; X represents a nonmetal atom selected from the groups 14-16 atoms, provided that X may bind with at least one hydrogen atom or substituent; and n is an integer from 0 to 2.

Among the compounds represented by formula (A), the compounds represented by formula (B) are preferred as a retardation enhancer.

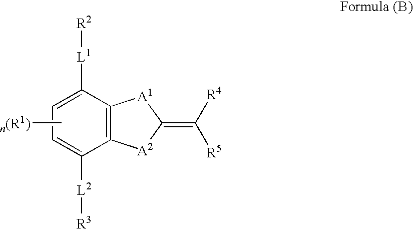

In formula (B), L¹ and L² independently represent a single bond or a divalent group. A^{l} and A² independently represent a group selected from the group consisting of —O—, —NR— where R represents a hydrogen atom or a substituent, —S— and —CO—. R¹, R² and R³ independently represent a substituent. And n is an integer from 0 to 2.

Preferred examples of the divalent linking group represented by L¹ or L² in the formula (A) or (B) include those shown below.

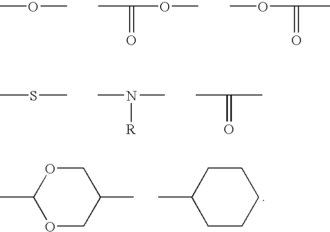

And further preferred are —O—, —COO— and —OCO—.

In formulae (A) and (B), R¹ represents a substituent, if there are two or more R, they may be same or different from each other, or form a ring. Examples of the substituent include those shown below.

Halogen atoms such as fluorine, chlorine, bromine and iodine atoms; alkyls (preferably C₁₋₃₀ alkyls) such as methyl, ethyl, n-propyl, iso-propyl, tert-butyl, n-octyl, and 2-ethylhexyl; cylcoalkyls (preferably C₃₋₃₀ substituted or non-substituted cycloalkyls) such as cyclohexyl, cyclopentyl and 4-n-dodecylcyclohexyl; bicycloalkyls (preferably C₅₋₃₀ substitute or non-substituted bicycloalkyls, namely monovalent residues formed from C₅₋₃₀ bicycloalkanes from which a hydrogen atom is removed) such as bicyclo [1,2,2]heptane-2-yl and bicyclo [2,2,2]octane-3-yl; alkenyls (preferably C₂₋₃₀ alkenyls) such as vinyl and allyl; cycloalkenyls (preferably C₃₋₃₀ substituted or non-substituted cycloalkenyls, namely monovalent residues formed from C₃₋₃₀ cycloalkenes from which a hydrogen atom is removed) such as 2-cyclopentene-1-yl and 2-cyclohexene-1-yl; bicycloalkenyls (preferably C₅₋₃₀ substituted or non-substituted bicycloalkenyls, namely monovalent residues formed from C₅₋₃₀ bicycloalkenes from which a hydrogen atom is removed) such as bicyclo[2,2,1]hepto-2-en-1-yl and bicyclo[2,2,2]octo-2-en-4-yl; alkynyls (preferably C₂₋₃₀ substitute or non-substituted alkynyls) such as etynyl and propargyl; aryls (preferably C₆₋₃₀ substitute or non-substituted aryls) such as phenyl, p-tolyl and naphthyl; heterocyclic groups (preferably (more preferably C₃₋₃₀) substituted or non-substituted, 5-membered or 6-membered, aromatic or non-aromatic heterocyclic monovalent residues) such as 2-furyl, 2-thienyl, 2-pyrimidinyl and 2-benzothiazolyl; cyano, hydroxyl, nitro, carboxyl, alkoxys (preferably C₁₋₃₀ substituted or non-substituted alkoxys) such as methoxy, ethoxy, iso-propoxy, t-butoxy, n-octyloxy and 2-methoxyethoxy; aryloxys (preferably C₆₋₃₀ substituted or non-substituted aryloxys) such as phenoxy, 2-methylphenoxy, 4-t-butylphenoxy, 3-nitrophenoxy and 2-tetradecanoyl aminophenoxy; silyloxys (preferably C₃₋₂₀ silyloxys) such as trimethylsilyloxy and t-butyldimethylsilyloxy; hetero-cyclic-oxys (preferably C₂₋₃₀ substituted or non-substituted hetero-cyclic-oxys) such as 1-phenyltetrazole-5-oxy and 2-tetrahydropyrenyloxy; acyloxys (preferably C₂₋₃₀ substitute or non-substituted alkylcarbonyloxys and C₆₋₃₀ substituted or non-substituted arylcarbonyloxys) such as formyloxy, acetyloxy, pivaloyloxy, stearoyoxy, benzoyloxy and p-methoxyphenylcarbonyloxy; carbamoyloxys (preferably C₁₋₃₀ substituted or non-substituted carbamoyloxys) such as N,N-dimethyl carbamoyloxy, N,N-diethyl carbamoyloxy, morpholinocarbonyloxy, N,N-di-n- octylaminocarbonyloxy and N-n-octylcarbamyloxy; alkoxy carbonyloxys (preferably C₂-₃₀ substituted or non-substituted alkoxy carbonyloxys) such as methoxy carbonyloxy, ethoxy carbonyloxy, t-butoxy carbonyloxy and n-octyloxy carbonyloxy; aryloxy carbonyloxys (preferably C₇₋₃₀ substituted or non-substituted aryloxy carbonyloxys) such as phenoxy carbonyloxy, p-methoxyphenoxy carbonyloxy and p-n-hexadecyloxyphenoxy carbonyloxy; aminos (preferably C₀₋₃₀ substituted or non-substituted alkylaminos and C₆₋₃₀ substituted or non-substituted arylaminos) such as amino, methylamino, dimethylamino, anilino, N-methyl-anilino and diphenylamino; acylaminos (preferably C₁₋₃₀ substituted or non-substituted alkylcarbonylaminos and C₆₋₃₀ substituted or non-substituted arylcarbonylaminos) such as formylamino, acetylamino, pivaloylamino, lauroylamino and benzoylamino; aminocarbonylaminos (preferably C₁₋₃₀ substituted or non-substituted aminocarbonylaminos) such as carbamoylamino, N,N-dimethylaminocarbonylamino, N,N-diethylamino carbonylamino and morpholino carbonylamino; alkoxycarbonylaminos (preferably C₂₋₃₀ substituted or non-substituted alkoxycarbonylaminos) such as methoxycarbonylamino, ethoxycarbonylamino, t-butoxycarbonylamino, n-octadecyloxycarbonylamino and N-methyl-methoxy carbonylamino; aryloxycarbonylaminos (preferably C₇₋₃₀ substituted or non-substituted aryloxycarbonylaminos) such as phenoxycarbonylamino, p-chloro phenoxycarbonylamino and m-n-octyloxy phenoxy carbonylamino; sulfamoylaminos (preferably C₀₋₃₀ substituted or non-substituted sulfamoylaminos) such as sulfamoylamino, N,N-dimethylamino sulfonylamino and N-n-octylamino sulfonylamino; alkyl- and aryl-sulfonylaminos (preferably C₁₋₃₀ substituted or non-substituted alkyl-sulfonylaminos and C₆₋₃₀ substituted or non-substituted aryl-sulfonylaminos) such as methyl-sulfonylamino, butyl-sulfonylamino, phenyl-sulfonylamino, 2,3,5-trichlorophenyl-sulfonylamino and p-methylphenyl-sulfonylamino; mercapto; alkylthios (preferably substituted or non-substituted C₁₋₃₀ alkylthios such as methylthio, ethylthio and n-hexadecylthio; arylthios (preferably C₆₋₃₀ substituted or non-substituted arylthios) such as phenylthio, p-chlorophenylthio and m-methoxyphenylthio; heterocyclic-thios (preferably C₂₋₃₀ substituted or non-substituted heterocyclic-thios such as 2-benzothiazolyl thio and 1-phenyltetrazol-5-yl-thio; sulfamoyls (preferably C₀₋₃₀ substituted or non-substituted sulfamoyls) such as N-ethylsulfamoyl, N-(3-dodecyloxypropyl)sulfamoyl, N,N-dimethylsulfamoyl, N-acetylsulfamoyl, N-benzoylsulfamoyl, N—(N′-phenylcarbamoyl)sulfamoyl; sulfo; alkyl- and aryl-sulfinyls (preferably C₁₋₃₀ substituted or non-substituted alkyl- or C₆₋₃₀ substituted or non-substituted aryl-sulfinyls) such as methylsulfinyl, ethylsulfinyl, phenylsulfinyl and p-methylphenylsulfinyl; alkyl- and aryl-sulfonyls (preferably C₁₋₃₀ substituted or non-substituted alkyl-sulfonyls and C₆₋₃₀ substituted or non-substituted arylsulfonyls) such as methylsulfonyl, ethylsulfonyl, phenylsulfonyl and p-methylphenylsulfonyl; acyls (preferably C₂₋₃₀ substituted non-substituted alkylcarbonyls, and C₇₋₃₀ substituted or non-substituted arylcarbonyls) such as formyl, acetyl and pivaloyl benzyl; aryloxycarbonyls (preferably C₇₋₃₀ substituted or non-substituted aryloxycarbonyls) such as phenoxycarbonyl, o-chlorophenoxycarbonyl, m-nitrophenoxycarbonyl and p-t-butylphenoxycarbonyl; alkoxycarbonyls (preferably C₂₋₃₀ substituted or non-substituted alkoxycarbonyls) methoxycarbonyl, ethoxycarbonyl, t-butoxycarbonyl and n-octadecyloxycarbonyl; carbamoyls (preferably C₁₋₃₀ substituted or non-substituted carbamoyls) such as carbamoyl, N-methylcarbamoyl, N,N-dimethylcarbamoyl, N,N-di-n-octylcarbamoyl and N-(methylsulfonyl)carbamoyl; aryl- and heterocyclic-azos (preferably C₆₋₃₀ substituted or non-substituted arylazos and C₃₋₃₀ substituted or non-substituted heterocyclicazos) such as phenylazo and p-chlorophenylazo, 5-ethylthio-1,3,4-thiadiazol-2-yl-azo, imides such as N-succinimide and N-phthalimide; phosphinos (preferably C₂₋₃₀ substituted or non-substituted phosphinos) such as dimethyl phosphino, diphenyl phosphino and methylphenoxy phosphino; phosphinyls (preferably C₂₋₃₀ substituted or non-substituted phosphinyls) such as phosphinyl, dioctyloxy phosphinyl and diethoxy phosphinyl; phosphinyloxys (preferably C₂₋₃₀ substituted or non-substituted phosphinyloxys) such as diphenoxyphosphinyloxy and dioctyloxyphosphinyloxy; phosphinylaminos (preferably C₂₋₃₀ substituted or non-substituted phosphinylaminos) such as dimethoxy phosphinylamino and dimethylamino phosphinylamino; and silyls (preferably C₃₋₃₀ substituted or non-substituted silyls) such as trimethylsilyl, t-butylmethylsilyl and phenyldimethylsilyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

Preferably, R¹ represents a hydrogen atom, an alkyl group, an alkenyl group, an aryl group, a heterocyclic group, hydroxyl, carboxyl, an alkoxy group, an acyloxy group, cyano or an amino group; and more preferably, a halogen atom, an alkyl group, cyano or an alkoxy group.

R² and R³ independently represent a substituent. Examples of the substituent include those exemplified above as examples of R¹. Preferably, R² and R³ independently represent a substituted or non-substituted phenyl or a substituted or non-substituted cyclohexyl; more preferably, a substituted phenyl or a substituted cyclohexyl; and much more preferably, a phenyl having a substituent at a 4-position or a cyclohexyl having a substituent at a 4-position.

R⁴ and R⁵ independently represent a substituent. Examples of the substituent include those exemplified above as examples of R¹. Preferably, R⁴ and R⁵ independently represent an electron-attractant group having the Hammett value, σₚ, more than 0; more preferably an electron-attractant group having the Hammett value, σₚ, from 0 to 1.5. Examples of such an electron-attractant group include trifluoromethyl, cyano, carbonyl and nitro. R⁴ and R⁵ may bind to each other to form a ring.

It is to be noted that, regarding Hammett constant of the substituent, σₚ and σₘ, there are detailed commentaries on the Hammett constant of the substituent, σₚ and σₘ in “Hammett Rule-Structure and Reactivity-(Hammeto soku—Kozo to Hanohsei)” published by Maruzen and written by Naoki Inamoto; “New Experimental Chemistry 14 Synthesis and Reaction of Organic Compound V (Shin Jikken Kagaku Koza 14 Yuuki Kagoubutsu no Gousei to Hannou)” on p. 2605, edited by Chemical Society of Japan and published by Maruzen; “Theory Organic Chemistry Review (Riron Yuuki Kagaku Gaisetsu)”on p. 217, published by TOKYO KAGAKU DOZIN CO. LTD., and written by Tadao Nakatani; and Chemical Reviews, Vol. 91, No. 2, pp. 165-195(1991).

In the formula, A^{l} and A² independently represent a group selected from the group consisting of —O—, —NR— where R represents a hydrogen atom or a substituent, —S— and —CO—;and preferably, —O—, —NR— where R represents a substituent selected from those exemplified above as examples of R¹, or —S—.

In the formula, X represents a nonmetal atom selected from the groups 14-16 atoms, provided that X may bind with at least one hydrogen atom or substituent. Preferably, X represents ═O, ═S, ═NR or ═C(R)R where R represents a substituent selected from those exemplified as examples of R¹.

In the formula, n is an integer from 0 to 2, and preferably 0 or 1.

Examples of the compound represented by the formula (A) or (B) include, but examples of the Re enhancer are not limited to, those shown below. Regarding the compounds shown below, each compound to which is appended (X) is referred to as “Example Compound (X)” unless it is specified.

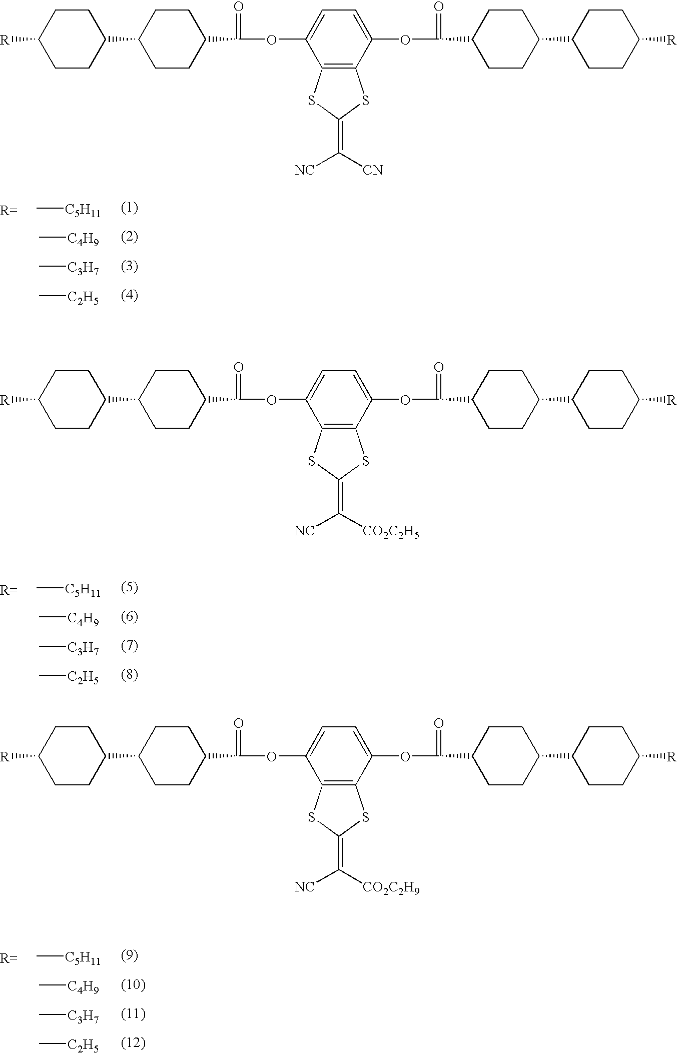

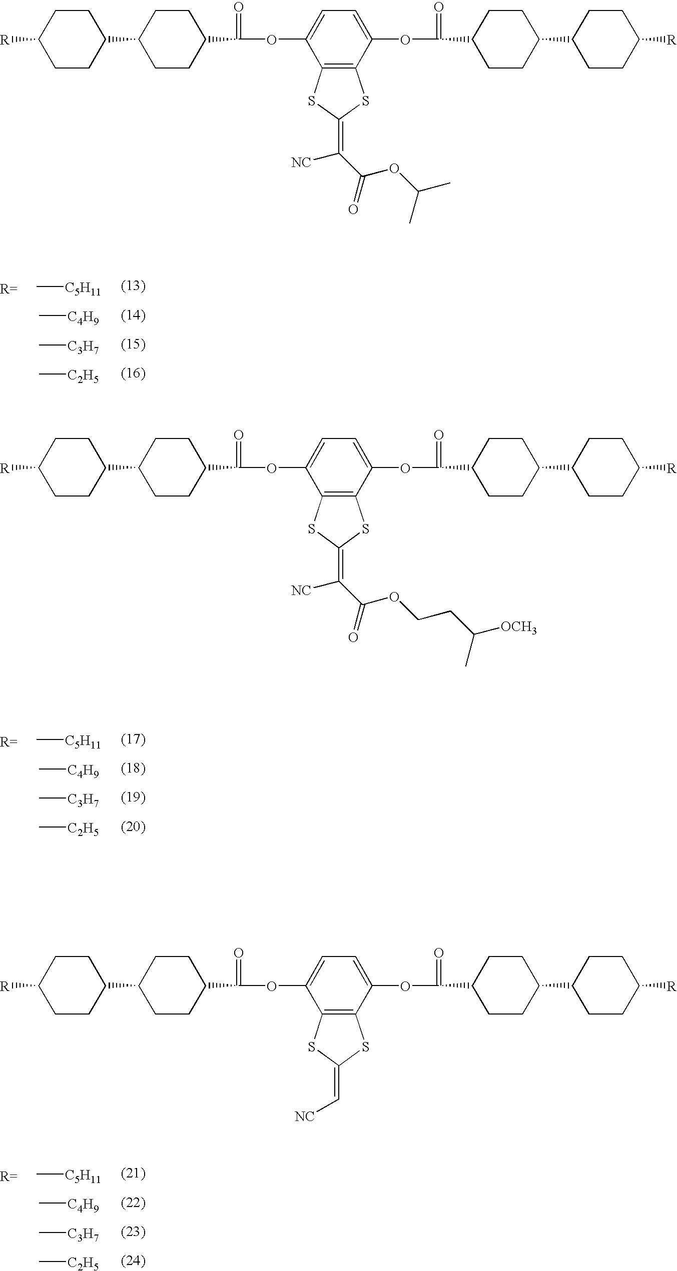

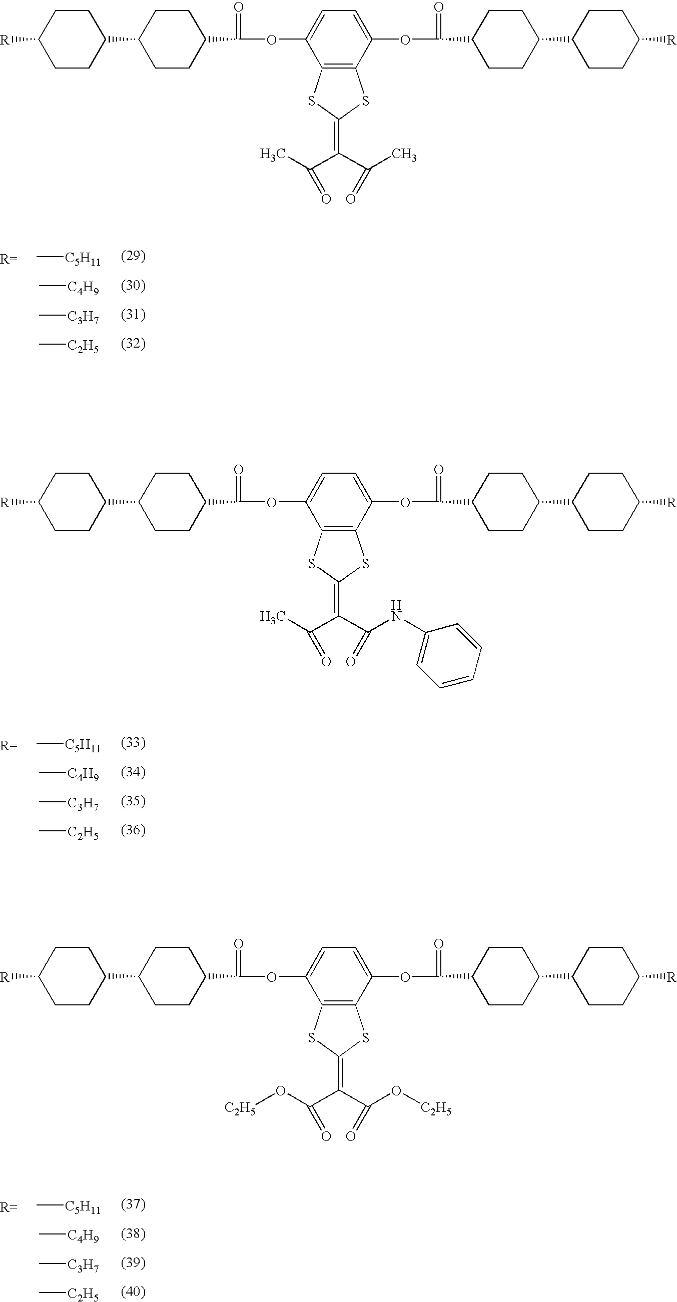

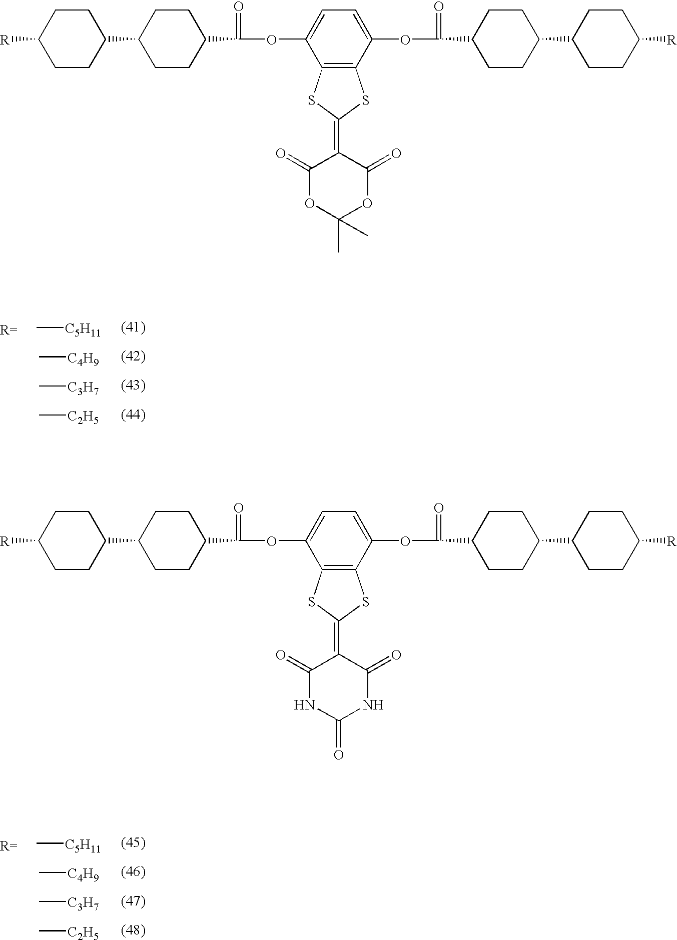

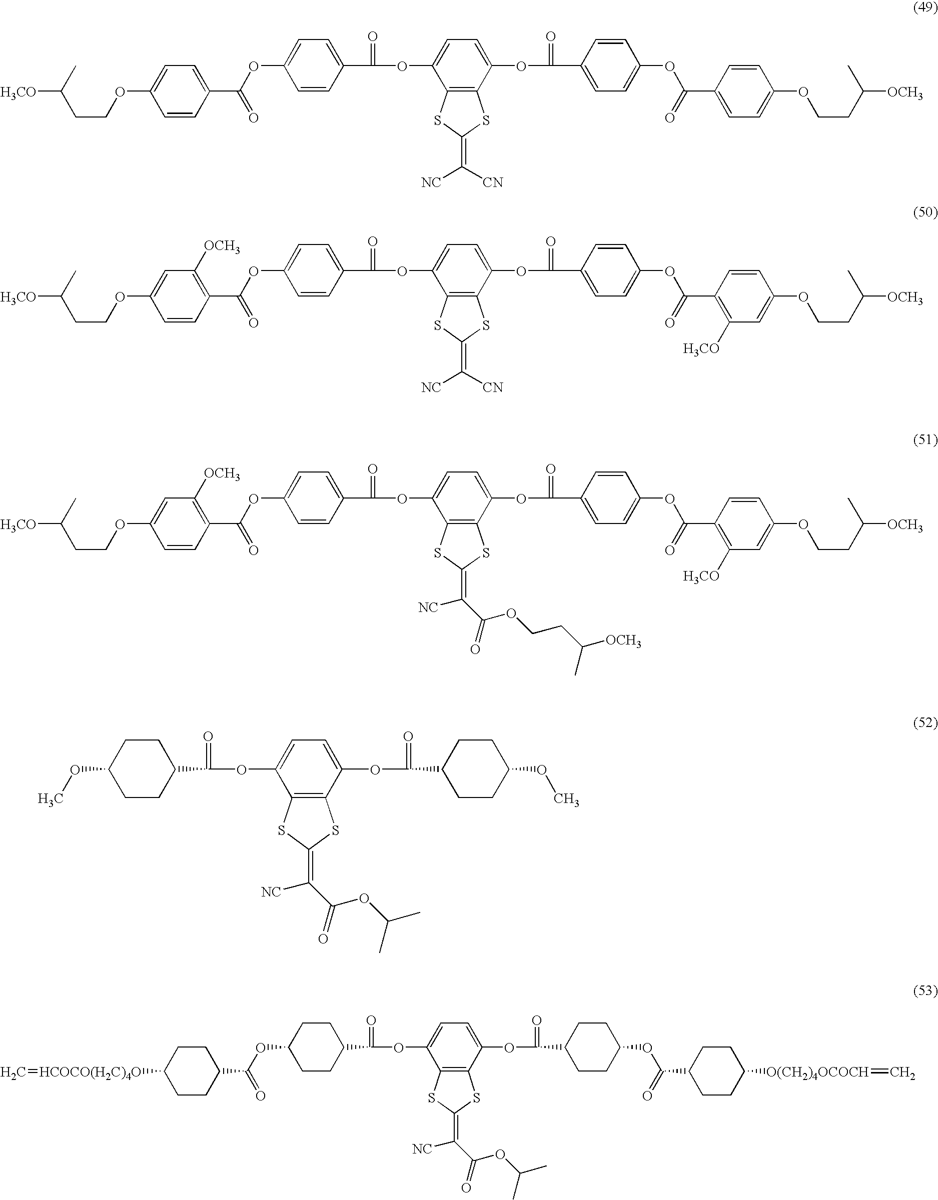

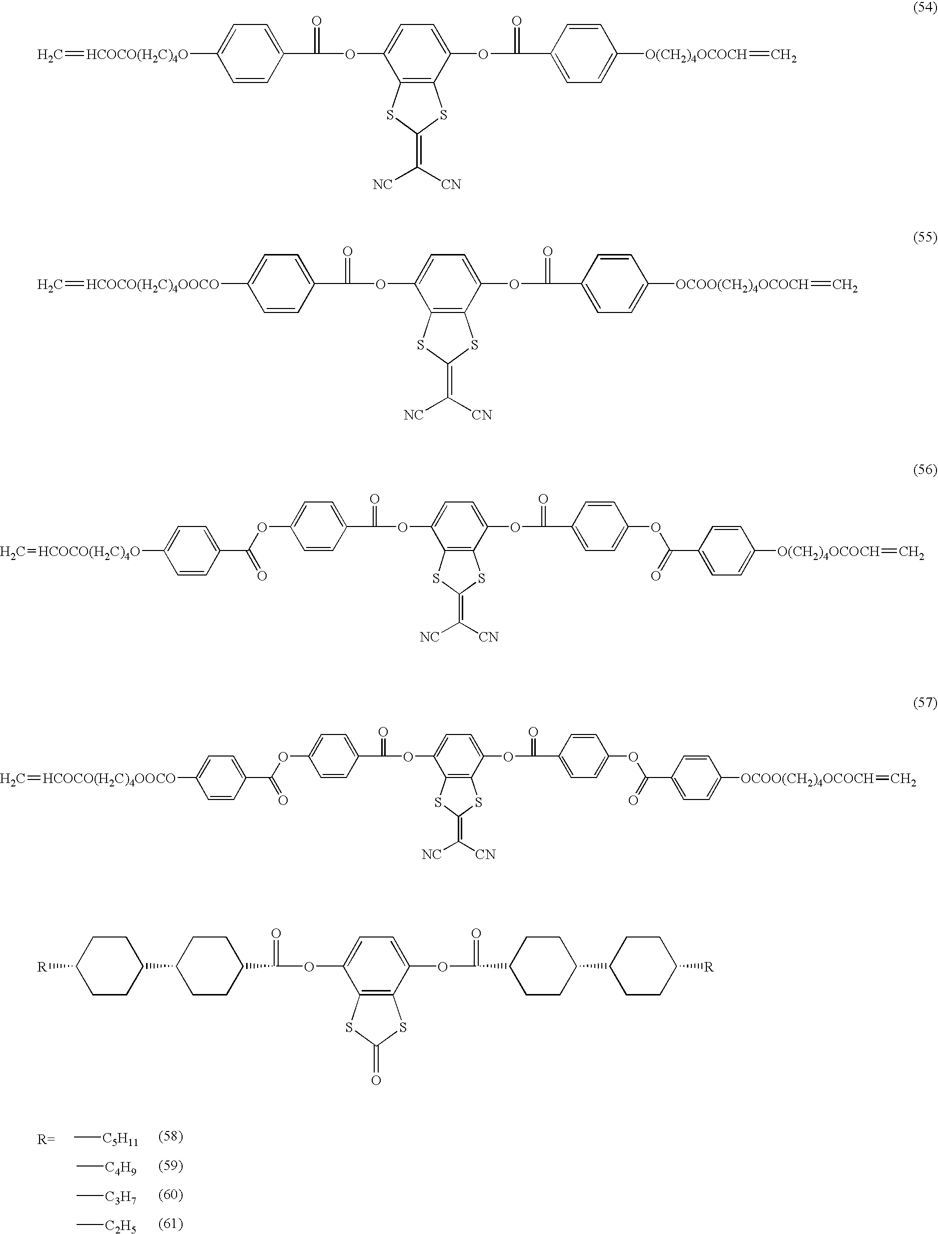

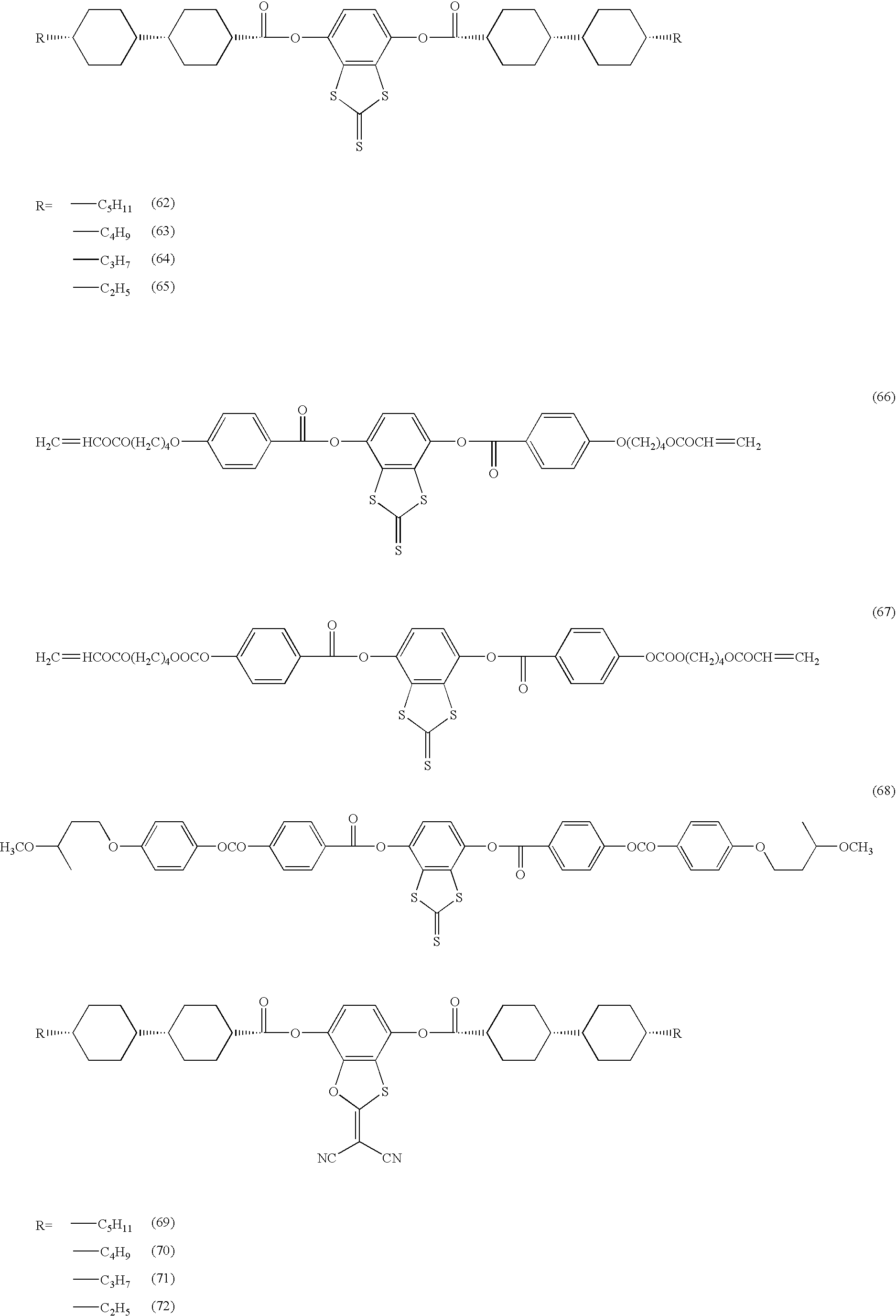

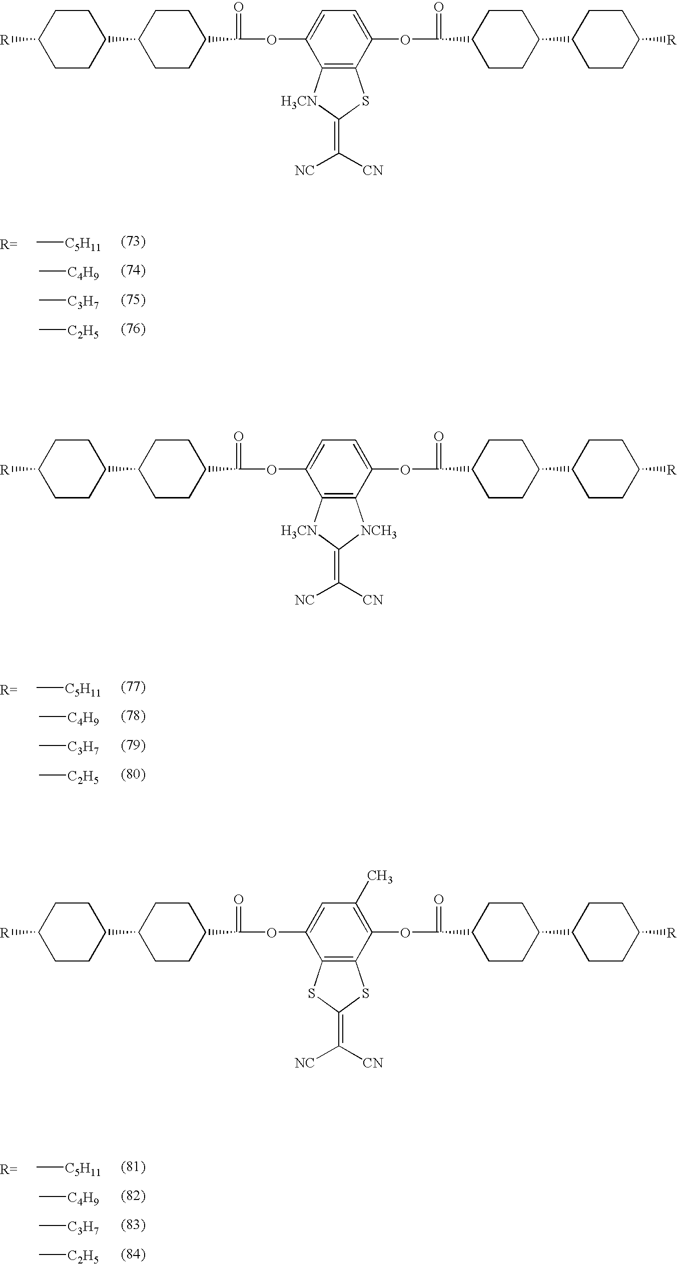

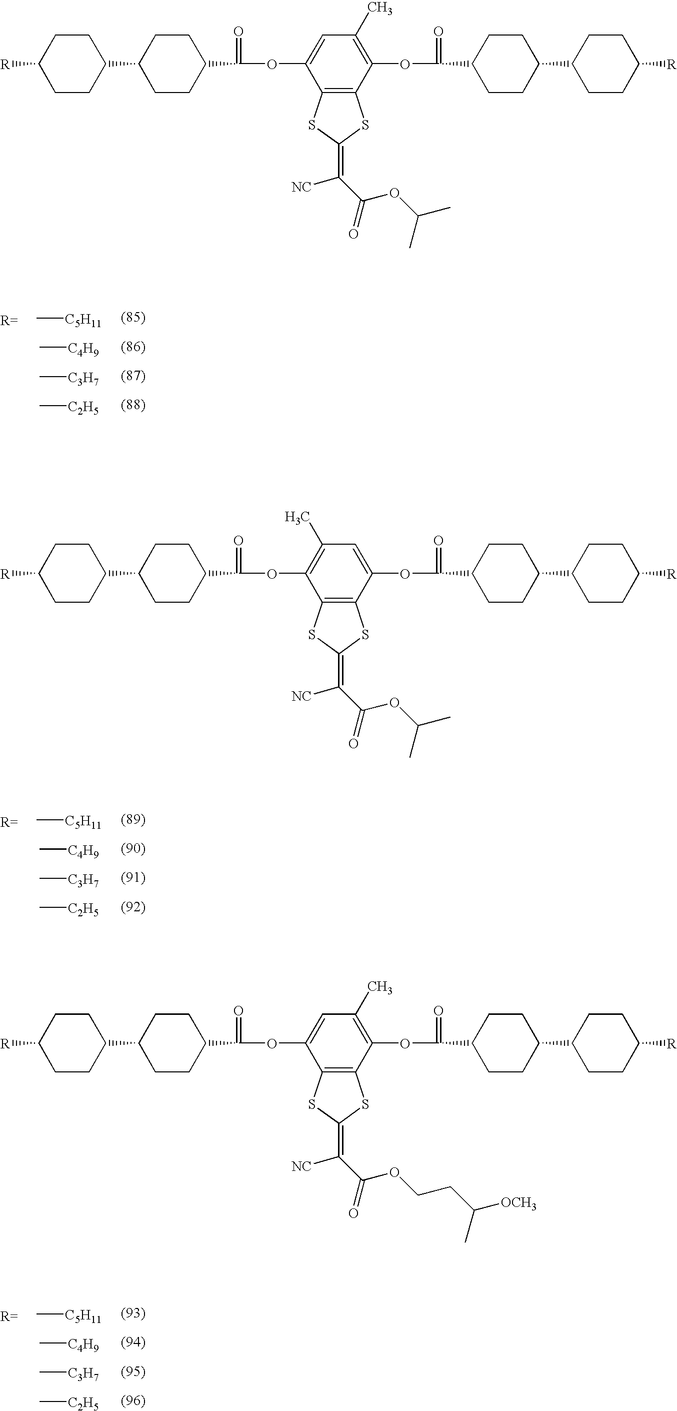

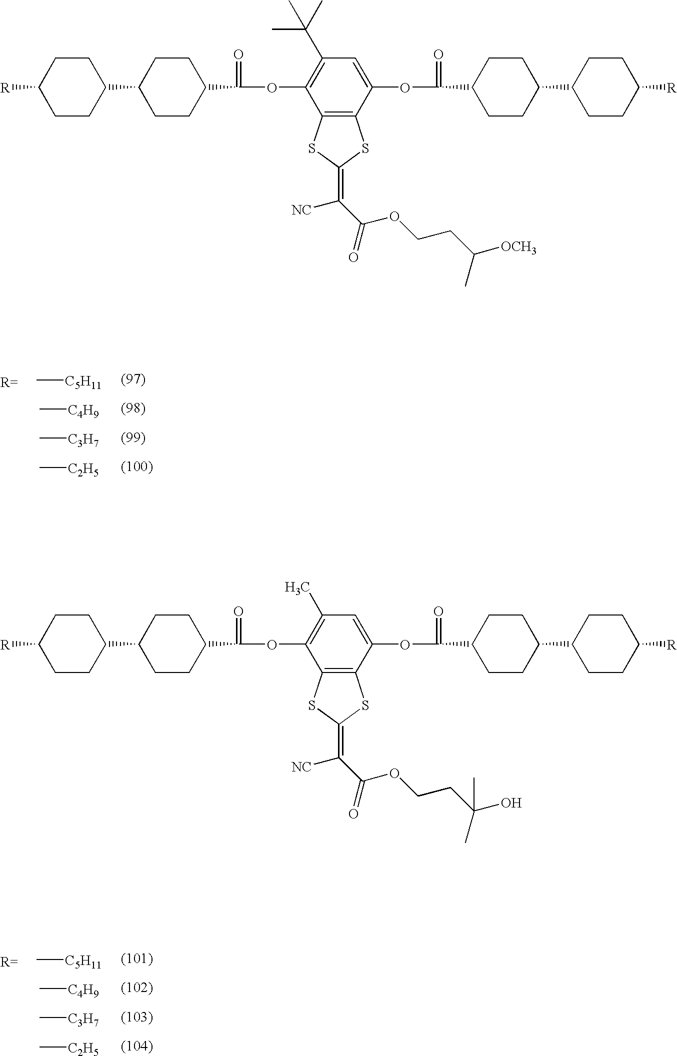

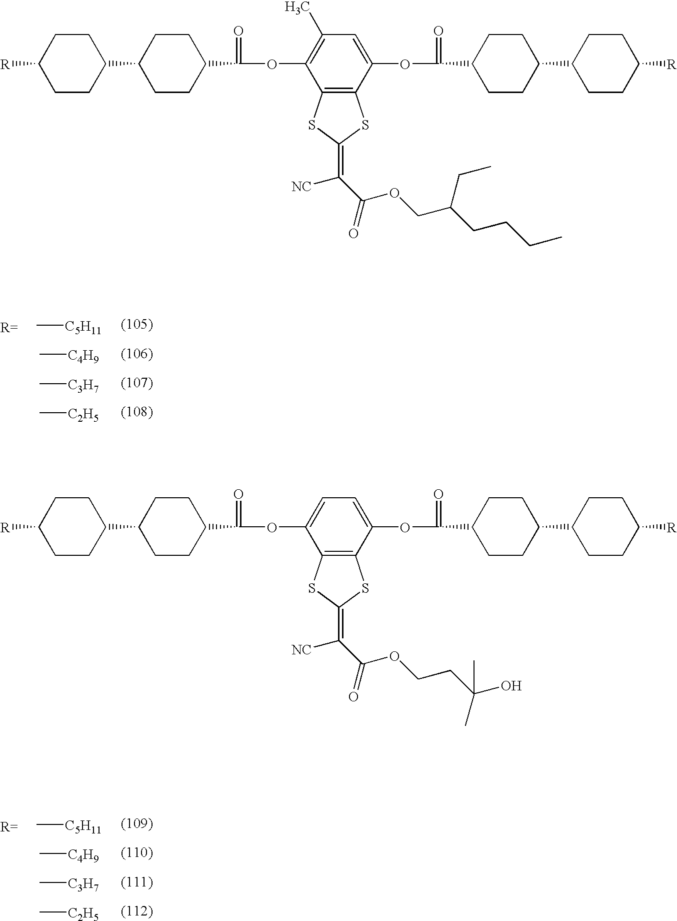

The compound represented by the formula (A) or (B) may be synthesized referring to known methods. For example, Example Compound (1) may be synthesized according to the following scheme.

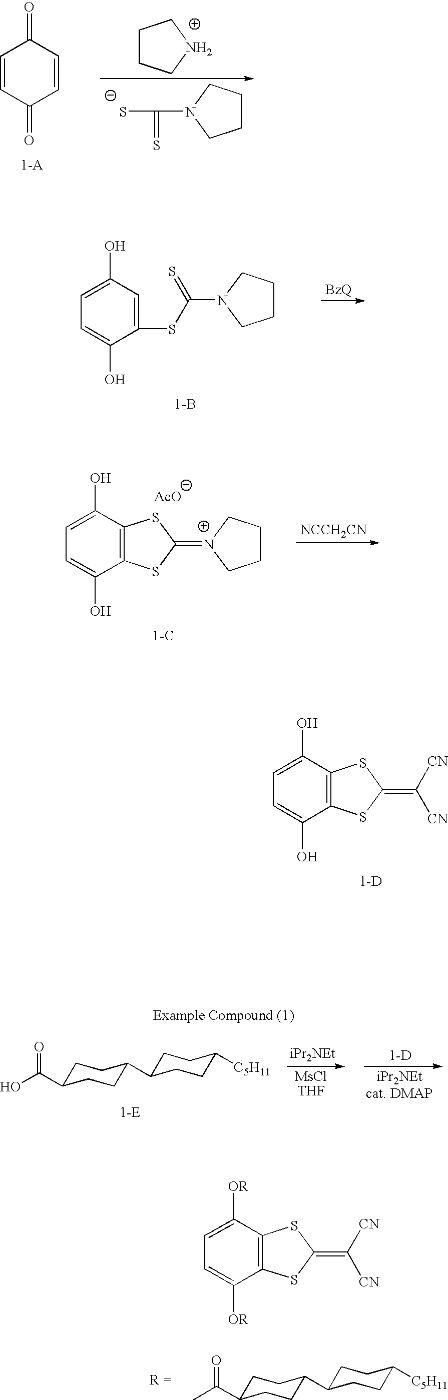

In the above scheme, the steps for producing Compound (1-d) from Compound (1-A) may be carried out referring to the description in “Journal of Chemical Crystallography” (1997); 27(9); p. 515-526.

As shown in the above scheme, Example Compound (1) may be produced as follows. A tetrahydrofuran solution of Compound (1-E) is added with methanesulfonic acid chloride, added dropewise with N,N-di-iso-propylethylamine and then stirred. After that, the reaction solution is added with N,N-di-iso-propylethylamine, added dropewise with a tetrahydrofuran of Compound (1-D), and then added dropewise with a tetrahydrofuran solution of N,N-dimethylamino pyridine (DMAP).

### Plasticizer:

The cellulose ester film of the invention preferably contains a plasticizer for enhancing the film formability. The plasticizer is preferably a saccharide plasticizer selected from a compound group of saccharides and their derivatives, or an oligomer plasticizer selected from oligomers. Containing the plasticizer of the type, the environmental moisture durability of the cellulose ester film may be enhanced. Concretely, the plasticizer may reduce the moisture-dependent Rth fluctuation, |ΔRth| of the film; and |ΔRth| of the film measured under the above-mentioned condition may be equal to or less than 8 nm. When both the saccharide plasticizer and the oligomer plasticizer are added as combined, they are more effective for reducing |ΔRth| of the film.

### Saccharide Plasticizer:

As described in the above, the cellulose ester film of the invention contains at least one compound selected from a compound group of saccharides and their derivatives. Above all, compounds selected from a compound group consisting of monomers or 2- to 10-multimers of saccharides and their derivatives in an amount of from 0.1% by mass to 20% by mass are preferred as the plasticizer. Their examples include saccharide derivatives where the hydrogen atom of OH in a saccharide such as glucose is partly or wholly substituted with an acyl group, as in WO2007/125764, [0042] to [0065]. The amount of the saccharide plasticizer to be added is preferably from 0.1% by mass to less than 20% by mass of the main ingredient, cellulose ester, more preferably from 0.1% by mass to less than 10% by mass, even more preferably from 0.1% by mass to less than 7% by mass.

### Oligomer Plasticizer:

As described in the above, the cellulose ester film of the invention preferably contains an oligomer plasticizer selected from oligomers. Preferred examples of the oligomer plasticizer include polycondensation-esters of a diol component and a dicarboxylic acid compound and their derivatives (hereinafter this may be referred to as “polycondensation-ester plasticizer”), and oligomers of methyl acrylate (MA) and their derivatives (hereinafter this may be referred to as “MA oligomer plasticizer”).

The polycondensation-esters are those of a dicarboxylic acid component and a diol component. The dicarboxylic acid component may be one dicarboxylic acid or a mixture of two or more dicarboxylic acids. Above all, at least one aromatic dicarboxylic acid and at least one aliphatic dicarboxylic acid are preferably used as the dicarboxylic acid component. On the other hand, the diol component may also be one diol component or a mixture of two or more diols. Above all, as the diol component, preferred is ethylene glycol and/or an aliphatic diol having from more than 2.0 to 3.0 carbon atoms on average.

The ratio of the aromatic dicarboxylic acid to the aliphatic dicarboxylic acid in the carboxylic acid component is preferably such that the aromatic dicarboxylic acid accounts for from 5 to 70 mol %. Within the range, the environmental moisture dependence of the optical properties of the film may be reduced, and during the film formation, the plasticizer may be prevented from bleeding out. The aromatic dicarboxylic acid in the dicarboxylic acid component more preferably accounts for from 10 to 60 mol %, even more preferably from 20 to 50 mol %.

Examples of the aromatic dicarboxylic acid include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid and 2,6-naphthalene dicarboxylic acid; and among these, phthalic acid and terephthalic acid are preferable. Examples of the aliphatic dicarboxylic acid include oxalic acid, malonic acid, succinic acid, maleic acid, fumaric acid, glutaric acid, adipic acid, pimelic acid, suberic acid, azelaic acid, sebacic acid, dodecane dicarboxylic acid, and 1,4-cyclohexane dicarboxylic acid.; and among these, succinic acid and adipic acid are preferable.

The diol component may be ethylene glycol and/or an aliphatic diol having from more than 2.0 to 3.0 carbon atoms on average. The molar ratio of ethylene glycol is preferably equal to or more than 50 mol % and more preferably equal to or more than 75 mol % with respect to the total mole of the diol component. Examples of aliphatic diol include alkyl diols and alicyclic diols such as ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethyrol pentane), 2-n-butyl-2-ethyl-1,3-propanediol (3,3-dimethyrol heptane), 3-methyl-1,5-pentanediol, 1,6-hexanediol, 2,2,4-trimethy1-1,3-pentanediol, 2-ethyl-1,3-hexanediol, 2-methyl-1,8-octanediol, 1,9-nonanediol, 1,10-decanediol, 1,12-octadecanediol and diethylene glycol; and one or more selected from these are preferably used along with ethylene glycol.

The diol component is preferably ethylene glycol, 1,2-propanediol or 1,3-propanediol, and more preferably ethylene glycol or 1,2-propanediol.

The polycondensation-ester plasticizer is preferably a polycondensation-ester derivative in which the terminal OH of the polycondensate ester forms an ester with a monocarboxylic acid. The monocarboxylic acid for use for blocking both terminal OH groups is preferably an aliphatic monocarboxylic acid, more preferably acetic acid, propionic acid, butanoic acid, benzoic acid and their derivatives, etc., even more preferably acetic acid or propionic acid, most preferably acetic acid. When the number of the carbon atoms constituting the monocarboxylic acid for use for both terminals of the polycondensate ester is equal to or less than 3, then the heating loss of the compound is not large and the surface defectives in the film may be reduced. A mixture of two or more different types of monocarboxylic acids may be used for terminal blocking. Preferably, both terminals of the polycondensation-ester are blocked with acetic acid or propionic acid, and more preferably, they are blocked with acetic acid to give polycondensation-ester derivatives having an acetyl ester residue at both terminals.

The polycondensation-esters and their derivatives are preferably oligomers having a number-average molecular weight of from 700 to 2000 or so, more preferably from 800 to 1500 or so, even more preferably from 900 to 1200 or so. The number-average molecular weight of the polycondensation-ester may be measured and evaluated through gel permeation chromatography.

Examples of he polycondensation-ester plasitizer include, but are not limited to, those shown below.

| | Dicarboxylic acid | | | | | | | |
|---|---|---|---|---|---|---|---|---|
| | | | Ratio of | Diol | | | | Number- |
| | Aromatic | Aliphatic | dicarboxylic | | Ratio of | mean number of | | averaged |
| | dicarboxylic | dicarboxylic | acids | Aliphatic | diol(s) | carbon atom(s) | Both | molecular |
| | acid | acid | (mol %) | diol | (mol %) | in diol(s) | terminals | weight |
| P-1 | PA | AA | 10/90 | Ethylene | 100 | 2.0 | Acetyl ester | 1000 |
| | | | | glycol | | | residue | |
| P-2 | PA | AA | 25/75 | Ethylene | 100 | 2.0 | Acetyl ester | 1000 |
| | | | | glycol | | | residue | |
| P3 | PA | AA | 50/50 | Ethylene | 100 | 2.0 | Acetyl ester | 1000 |
| | | | | glycol | | | residue | |
| P-4 | PA | SA | 5/95 | Ethylene | 100 | 2.0 | Acetyl ester | 1000 |
| | | | | glycol | | | residue | |
| P-5 | PA | SA | 20/80 | Ethylene | 100 | 2.0 | Acetyl ester | 1000 |
| | | | | glycol | | | residue | |
| P-6 | TPA | AA | 15/85 | Ethylene | 100 | 2.0 | Acetyl ester | 1000 |
| | | | | glycol | | | residue | |
| P-7 | TPA | AA | 50/50 | Ethylene | 100 | 2.0 | Acetyl ester | 1000 |
| | | | | glycol | | | residue | |
| P-8 | TPA | SA | 5/95 | Ethylene | 100 | 2.0 | Acetyl ester | 1000 |
| | | | | glycol | | | residue | |
| P-9 | TPA | SA | 10/90 | Ethylene | 100 | 2.0 | Acetyl ester | 1000 |
| | | | | glycol | | | residue | |
| P-10 | TPA | SA | 15/85 | Ethylene | 100 | 2.0 | Acetyl ester | 1000 |
| | | | | glycol | | | residue | |
| P-11 | TPA | SA | 50/50 | Ethylene | 100 | 2.0 | Acetyl ester | 1000 |
| | | | | glycol | | | residue | |
| P-12 | TPA | SA | 70/30 | Ethylene | 100 | 2.0 | Acetyl ester | 1000 |
| | | | | glycol | | | residue | |
| P-13 | TPA/PA | AA | 10/10/80 | Ethylene | 100 | 2.0 | Acetyl ester | 1000 |
| | | | | glycol | | | residue | |
| P-14 | TPA/PA | AA | 20/20/60 | Ethylene | 100 | 2.0 | Acetyl ester | 1000 |
| | | | | glycol | | | residue | |
| P-15 | TPA/PA | AA/SA | 10/10/40/40 | Ethylene | 100 | 2.0 | Acetyl ester | 1000 |
| | | | | glycol | | | residue | |
| P-16 | TPA | AA/SA | 10/30/60 | Ethylene | 100 | 2.0 | Acetyl ester | 1000 |
| | | | | glycol | | | residue | |
| P-17 | TPA | AA/SA | 10/30/60 | Ethylene | 50/50 | 2.5 | Acetyl ester | 1000 |
| | | | | glycol/1,2- | | | residue | |
| | | | | propanediol | | | | |
| P-18 | TPA | AA/SA | 10/30/60 | 1,2- | 100 | 3.0 | Acetyl ester | 1000 |
| | | | | propanediol | | | residue | |
| P-19 | TPA | AA/SA | 10/30/60 | Ethylene | 100 | 2.0 | Acetyl ester | 700 |
| | | | | glycol | | | residue | |
| P-20 | TPA | AA/SA | 10/30/60 | Ethylene | 100 | 2.0 | Acetyl ester | 850 |
| | | | | glycol | | | residue | |
| P-21 | TPA | AA/SA | 10/30/60 | Ethylene | 100 | 2.0 | Acetyl ester | 1200 |
| | | | | glycol | | | residue | |
| P-22 | TPA | AA/SA | 10/30/60 | Ethylene | 100 | 2.0 | Acetyl ester | 1600 |
| | | | | glycol | | | residue | |
| P-23 | TPA | AA/SA | 10/30/60 | Ethylene | 100 | 2.0 | Acetyl ester | 2000 |
| | | | | glycol | | | residue | |
| P-24 | TPA | AA/SA | 10/30/60 | Ethylene | 100 | 2.0 | Propionyl ester | 1000 |
| | | | | glycol | | | residue | |
| P-25 | TPA | AA/SA | 10/30/60 | Ethylene | 100 | 2.0 | Butanoyl ester | 1000 |
| | | | | glycol | | | residue | |
| P-26 | TPA | AA/SA | 10/30/60 | Ethylene | 100 | 2.0 | Benzoyl ester | 1000 |
| | | | | glycol | | | residue | |
| P-27 | IPA | AA/SA | 20/40/40 | Ethylene | 100 | 2.0 | Acetyl ester | 1000 |
| | | | | glycol | | | residue | |
| P-28 | 2,6-NPA | AA/SA | 20/40/40 | Ethylene | 100 | 2.0 | Acetyl ester | 1200 |
| | | | | glycol | | | residue | |
| P-29 | 1,5-NPA | AA/SA | 20/40/40 | Ethylene | 100 | 2.0 | Acetyl ester | 1200 |
| | | | | glycol | | | residue | |
| P-30 | 1,4-NPA | AA/SA | 20/40/40 | Ethylene | 100 | 2.0 | Acetyl ester | 1200 |
| | | | | glycol | | | residue | |
| P-31 | 1,8-NPA | AA/SA | 20/40/40 | Ethylene | 100 | 2.0 | Acetyl ester | 1200 |
| | | | | glycol | | | residue | |
| P-32 | 2,8-NPA | AA/SA | 20/40/40 | Ethylene | 100 | 2.0 | Acetyl ester | 1200 |
| | | | | glycol | | | residue | |

*1) PA: phthalic acid; TPA: terephthalic acid; IPA: isophthalic acid; AA: adipic acid; SA: succinic acid; 2,6-NPA: 2,6-naphthalene dicarboxylic acid; 2,8-NPA: 2,8-naphthalene dicarboxylic acid; 1,5-NPA: 1,5-naphthalene dicarboxylic acid; 1,4-NPA: 1,4-naphthalene dicarboxylic acid; 1,8-NPA: 1,8-naphthalene dicarboxylic acid

The polycondensation-ester can be produced with ease according to any conventional method, for example, according to a polyesterification, interesterification or thermal-fusing condensation method of a dicarboxylic acid component and a diol component, or an interfacial condensation method of an acid chloride of a dicarboxylic acid component and a glycol. Polycondensate esters usable in the invention are described in detail in Koichi Murai, “Plasticizers and their Theory and Applications” (by Miyuki Shobo, 1st Ed., issued on Mar. 1, 1973). In addition, also usable herein are materials described JP-A Nos. 5-155809, 5-155810, 5-197073, 2006-259494, 7-330670, 2006-342227, and 2007-3679.

The amount of the polycondensation-ester plasticizer to be added is preferably from 0.1 to 25% by mass of the amount of the main ingredient, cellulose ester, more preferably from 1 to 20% by mass, even more preferably from 3 to 15% by mass.

The content of the starting materials and the side products in the polycondensation-ester plasticizer, concretely aliphatic diols, dicarboxylates, diol esters and others, that may be in the film is preferably less than 1%, more preferably less than 0.5%. The dicarboxylate includes dimethyl phthalate, di(hydroxyethyl) phthalate, dimethyl terephthalate, di(hydroxyethyl) terephthalate, di(hydroxyethyl) adipate, di(hydroxyethyl) succinate, etc. The diol ester includes ethylene diacetate, propylene diacetate, etc.

As the plasticizer for the cellulose ester film of the invention, also preferred is a methyl methacrylate (MA) oligomer plasticizer. The MA oligomer plasticizer may be combined with the above-mentioned saccharide plasticizer for use herein. In the mode of combination use, the ratio by mass of the MA oligomer plasticizer to the saccharide plasticizer is preferably from ½ to ⅕, more preferably from ⅓ to ¼.

Examples of the MA-oligomer plasticizer include oligomers having a repeating unit shown below.

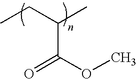

The weight-averaged molecular weight is preferably from about 500 to about 2000, more preferably from about 700 to about 1500; and more preferably from about 800 to about 1200.

Examples of the MA-oligomer plasticizer include both of oligomers of MA alone and oligomers having other repeating unit(s) along with the representing unit derived from MA. Examples of the other repeating unit(s) include any units derive from ethyl acrylate, i- or n-propyl acrylate, n-, s- or t-butyl acrylate, n-, i- or s-pentyl acrylate, n- or i-hexyl acrylate, n- or i-heptyl acrylate, n- or i-octyl acrylate, n- or i-nonyl acrylate, n- or i-myristyl acrylate, 2-ethylhexyl acrylate, ε-caprolactam acrylate, 2-hydroxyethyl acylate, 2-hydroxypropyl acrylate, 3-hydroxypropyl acrylate,4-hydroxybutyl acrylate, 2-hydroxybutyl acrylate, 2-methoxyethyl acrylate, 2-ethoxyethyl acrylate and methacrylates formed by replacing acrylic acid in the acrylates with methacrylic acid. Monomers having an aromatic ring(s) such as styrene, methyl styrene and hydroxy styrene may be used. As the other monomer(s), acrylate monomer(s) or methacrylate monomer(s), having no aromatic ring, are preferable.

The MA-oligomer plasticizer, having two or more repeating units derived from X which is a monomer having a hydrophilic group(s) and from Y which is a monomer having no hydrophilic group, may be used. Among such oligomers, those having a molar ratio of X to Y, X/Y, of from 1/1 to 1/99 are preferable.

The MA-oligomer may be prepared in reference to the method described in JP-A No. 2003-12859.

### Polymer Plasticizer:

The cellulose ester film of the invention may contain any other polymer plasticizer along with or in place of any one of the above-mentioned saccharide plasticizer, polycondensate ester plasticizer and MA oligomer plasticizer. The other polymer plasticizer includes polyester-polyurethane plasticizers, aliphatic hydrocarbon polymers, alicyclic hydrocarbon polymers; vinylic polymers such as polyvinyl isobutyl ether, poly-N-pyrrolidone, etc.; styrenic polymers such as polystyrene, poly-4-hydroxystyrene, etc.; polyethers such as polyethylene oxide, polypropylene oxide, etc.; polyamides, polyurethanes, polyureas, phenol-formaldehyde condensates, urea-formaldehyde condensates, polyvinyl acetate, etc.

### Compound Having at Least Two Aromatic Rings:

The cellulose ester film of the invention may contain a compound having at least 2 aromatic rings. The compound has an effect of controlling the optical properties of the cellulose ester film. For example, when the cellulose ester film of the invention is sued as an optical compensation film, it is effectively stretched for controlling the optical properties, especially Re thereof to be on a desired level. For increasing Re thereof, the in-plane refractive anisotropy of the film may be increased, for which one method comprises regulating the main chain orientation by stretching. As combined with stretching, a compound having a large refractivity anisotropy may be added to the film for further increasing the refractive anisotropy of the film. For example, when the film to which a compound having at least 2 aromatic ring is added as an additive thereto is stretched, the main chain of the polymer constituting the film is oriented, and with that, the compound itself becomes well orientable and the film may be controlled to have desired optical properties with ease.

The compound having at least 2 aromatic rings includes, for example, triazine compounds as in JP-A 2003-344655, rod-shaped compounds as in JP-A 2002-363343, crystalline compounds as in JP-A 2005-134884 and 2007-119737, etc. More preferred are triazine compounds and rod-shaped compounds. Two or more different types of compounds having at least 2 aromatic rings may be used, as combined. The molecular weight of the compound having at least 2 aromatic rings is preferably from 300 to 1200 or so, more preferably from 400 to 1000.

The amount of the compound having at least 2 aromatic rings to be added is preferably from 0.05% to 10% in terms of the ratio by mass to cellulose ester, more preferably from 0.5% to 8%, even more preferably from 1% to 5%.

### Optical Anisotropy-Controlling Agent:

An optical anisotropy-controlling agent may be added to the cellulose ester film. For example, its examples include “Rth-reducing compounds” described in JP-A 2006-30937, pp. 23-72.

### Mat Agent Fine Particles:

The cellulose ester film of the invention may contain fine particles as a mat agent. The fine particles usable in the invention are silicon dioxide, titanium dioxide, aluminium oxide, zirconium oxide, calcium carbonate, talc, clay, calcined kaolin, calcined calcium silicate, calcium silicate hydrate, aluminium silicate, magnesium silicate, and calcium phosphate. Preferably, the fine particles contain silicon as they are effective for reducing the haze of films. Especially preferably, they are silicon dioxide. It is desirable that the silicon dioxide fine particles have a primary mean particle size of at most 20 nm and an apparent specific gravity of at least 70 g/liter. More preferably, the mean particle size of the primary particles is small, falling between 5 and 16 nm, as they are effective for reducing the haze of the film. More preferably, the apparent specific gravity is from 90 to 200 g/liter, even more preferably from 100 to 200 g/liter. The particles having a larger apparent specific gravity may make it easier to form a dispersion having a higher concentration, and they are desirable as reducing the film haze and as preventing the formation of aggregates of the particles in the film.

The fine particles generally form secondary particles having a mean particle size of from 0.1 to 3.0 μm, and they exist as aggregates of their primary particles in the film, therefore forming projections having a size of from 0.1 to 3.0 μm in the film surface. The secondary mean particle size is preferably from 0.2 μm to 1.5 μm, more preferably from 0.4 μm to 1.2 μm, most preferably from 0.6 μm to 1.1 μm. The primary and secondary particle sizes are the diameters of the circumscribed circles of the particles in the film observed with a scanning electronic microscope. Concretely, 200 particles in different sites are observed and analyzed, and their mean value is the mean particle size.

As fine particles of silicon dioxide, for example, commercial products of Aerosil R972, R972V, R974, R812, 200, 200V, 300, R202, OX50, TT600 (all by Nippon Aerosil) are usable. As fine particles of zirconium oxide, for example, commercial products of Aerosil R976 and R811 (both by Nippon Aerosil) are usable.

Of those, Aerosil 200V and Aerosil R972V are fine particles of silicon dioxide having a primary mean particle size of at most 20 nm and having an apparent specific gravity of at least 70 g/liter, and these are especially preferred as they are effective for reducing the friction factor of optical films while keeping the haze of the films low.

One example of the method for preparing particles having a small secondary-particle diameter is carried out using a dispersion of fine particles. The dispersion may be prepared according to some methods. One example is as follows. A dispersion of fine particles is prepared by mixing solvent and fine particles and then stirred the mixture. And the fluid dispersion is added to a small amount of cellulose ester solution, which is prepared separately, under stirring. Then, the mixture is mixed with a dope fluid of cellulose ester, that is, a main ingredient. This method is preferable since fine particles of silica dioxide are well dispersed and hardly aggregate each other. Another example is as follows. A small amount of cellulose ester is added to solvent, and stirred. Then fine particles are added to the mixture and then mixed by using a disperser to prepare “a fine-particle additional fluid”. The fine-particle additional fluid is mixed with a dope fluid fully by using in-line mixer. Any method of them may be adapted, and the method is not limited to the above mentioned methods. Preferably, the concentration of silica dioxide fine particles to be mixed and dispersed in a solvent to prepare a dispersion of the particles is from 5 to 30% by mass, more preferably from 10 to 25% by mass, even more preferably from 15 to 20% by mass. The dispersion concentration is preferably higher, as the liquid turbidity could be smaller relative to the amount of the particles in the dispersion, the haze of the film could be lower and the content of the aggregates in the film could be smaller. The amount of the mat agent to be finally in the polymer dope solution is preferably from 0.01 to 1 g per 1 m², more preferably from 0.03 to 0.3 g per 1 m², and even more preferably from 0.08 to 0.16 g per 1 m².

Examples of the solvent to be used in the method described above include lower alcohols such as methyl alcohol, ethyl alcohol, propyl alcohol, isopropyl alcohol, butyl alcohol. The other solvents than such lower alcohols are not specifically defined for use herein. Preferably, the solvents generally used in film formation from cellulose esters may be used.

### (Low-Molecular Plasticizer, Degradation Inhibitor, Release Agent)

Various additives (e.g., low-molecular plasticizer, UV inhibitor, degradation inhibitor, release agent, IR absorbent, etc.) may be added to the cellulose ester film in the process of producing the film, depending on the applications of the film. The additives may be solid or oily, or that is, they are not specifically defined in point of their melting point and boiling point thereof. For example, for the additive, UV absorbents at 20 degrees Celsius or lower and at 20 degrees Celsius or higher may be mixed, or plasticizers may also be mixed in the same manner. For example, these are described in JP-A 201-151901. IR absorbent dyes are described in, for example, JP-A 2001-194522. The time at which the additive is added may be in any stage in the step of dope preparation; however, the additive may be added in the final stage of the dope preparation step. Not specifically defined, the amount of the material to be added may be any one capable expressing the function thereof. In case where the cellulose ester film is formed of plural layers, then the type and the amount of the additive to be added to the constitutive layers may differ. For example, as in JP-A 2001-151902, the related technique is known in the art. Regarding the details of the additives, the materials described in Hatsumei Kyokai Disclosure Bulletin No. 2001-1745 (published in March 15, 2001 by Hatsumei Kyokai) in p.p. 16-22 are preferred for use in the invention.

### 1.-3 Production Method for Cellulose Ester Film:

The cellulose ester film of the invention is preferably produced according to a solvent-casting method. According to a solvent-casting method, a dope prepared by dissolving a polymer in an organic solvent is cast onto the surface of a support of a metal or the like, and dried thereon to form a film. Next, the film is peeled away from the support surface, and stretched.

The cellulose ester film is preferably produced according to a solvent-casting method. Examples of production of cellulose ester film according to a solvent-casting method are given in U.S. Pat. Nos. 2,336,310, 2,367,603, 2,492,078, 2,492,977, 2,492,978, 2,607,704, 2,739,069 and 2,739,070, British Patents 640731, 736892, JP-B 45-4554, 49-5614, and JPA Nos. syo 60-176834, syo 60-203430, and syo 62-115035, and their descriptions are referred to herein. The cellulose ester film may be stretched. Regarding the method and condition for stretching treatment, for example, referred to are JPA Nos. syo 62-115035, hei 4-152125, hei 4-284511, hei 4-298310, and hei 11-48271.

### 1.-4 Characteristics of Cellulose Ester Film:

### Re and Rth:

The preferred range of the optical characteristics of the cellulose ester film of the invention changes depending on the use of the film. In an embodiment where the film is used in a VA-mode liquid-crystal display device, preferably, its Re(589) is from 40 nm to 70 nm, and its Rth(589) is from 90 nm to 220 mm; more preferably, its Re(589) is from 45 nm to 65 nm, and its Rth(589) is from 100 nm to 160 nm; even more preferably, its Re(589) is from 50 nm to 60 nm, and its Rth(589) is from 110 nm to 150 nm.

### Film Thickness:

In an embodiment where the cellulose ester film of the invention is used as a part in a device that is desired to have a thinned body, for example, as a part of a liquid-crystal display device or the like, the film is preferably thinner. However, if too thin, the film could not exhibit the optical characteristics necessary for the use. In an embodiment where the film of the invention is used as an optical compensatory film in a liquid-crystal display device, or as a protective film for a polarizer, the film thickness is preferably from 20 to 80 μm or so, more preferably from 25 to 70 μm or so, even more preferably from 30 to 60 μm or so.

### Haze:

The cellulose ester film of the invention preferably has a low haze. The film having a low haze is favorable since it does not lower the contrast on the front (in the normal direction relative to the panel surface) of a liquid-crystal display device comprising it. The cellulose ester film of the invention may have a haze of at most 0.5%, more preferably at most 0.4%, even more preferably at most 0.3%. The lowermost limit of the haze is not specifically defined.

In this description, the haze of the film may be measured as follows: A film sample of 40 mm×80 mm is prepared, and in an environment at 25° C. and 60% RH, its haze is measured with a haze meter (HGM-2DP, by Suga Test Instruments) according to JIS K-6714.

### Axial Misalignment:

When a film having a slow axis in the direction perpendicular to the film-traveling direction, or that is, in the cross direction of the film is stretched with a tenter, then the slow axis of the film may be deviated (bowed) more on the outer side thereof, even though the slow axis thereof could be in that perpendicular direction in the center of the film. The width of the film produced according to a solvent casting method means the length of the film in the direction perpendicular to the dope-casting direction.

Preferably, the axial misalignment of the slow axis of the cellulose ester film of the invention is as small as possible in the entire width of the film. Concretely, when the film is optically analyzed on a point taken in the entire width of the film, the axial misalignment of the slow axis of the film is preferably at most 0.4 degrees, or that is, the axial misalignment thereof preferably falls within a range of from −0.4 degrees to 0.4 degrees relative to the perpendicular direction of 0 degree, more preferably, it is within ±0.3 degrees, even more preferably within ±0.2 degrees.

The slow axis of the film may be determined simultaneously with determination of the in-plane retardation thereof. Concretely, a small test piece is cut out of the film, completely in parallel to the end thereof in the film-traveling direction, and this is analyzed with KOBRA 21ADH or WR.

### 2. Use of Cellulose Ester Film:

The cellulose ester film of the invention has many applications. For example, it may be used as an optical compensatory film in liquid-crystal display devices, as a protective film of polarizers, etc.

### Optical Compensatory Film:

The cellulose ester film of the invention may be used as an optical compensatory film. “Optical compensatory film” means an optical material having optical anisotropy generally for use in display devices such as liquid-crystal display devices, etc., and this has the same meaning as that of an optical compensatory sheet or the like. In a liquid-crystal display device, such an optical compensatory film is used for the purpose of enhancing the contrast of the display panel, for enlarging the viewing angle and for solving a problem of color shift.

Plural cellulose ester films of the invention may be laminated, or the cellulose ester film of the invention may be laminated with any other retardation film, thereby suitably controlling Re and Rth of the resulting laminate to be an optical compensatory film. The film lamination may be attained with a sticking paste or an adhesive.

### Polarizing Plate:

The cellulose ester film of the invention may be used as a protective film for polarizing plate, and the invention provides a polarizing plate comprising the film. One example of the polarizing plate of the invention comprises a polarizing film and two protective films (transparent films) for protecting both surfaces of the polarizing film, in which the cellulose ester film of the invention is used as at least one of the polarizer-protective films. In an embodiment where the cellulose ester film of the invention is used as a support and an optically-anisotropic layer of a liquid-crystal composition is formed on the surface of the support, and where the cellulose ester film is used as a protective film for a polarizing plate, it is desirable that the back side (on which the optically-anisotropic layer is not formed) of the cellulose ester film of the invention serving as a support is stuck to the surface of the polarizing film.

In case where the cellulose ester film of the invention is used as a protective film for the polarizing plate, the cellulose ester film of the invention is preferably hydrophilicated through the above-mentioned surface-treatment (e.g., as described in JP-A 6-94915 and 6-118232), and for example, the film is preferably processed for glow discharge treatment, corona discharge treatment, or alkali saponification. In particular, the surface treatment of the film is most preferably alkali saponification.

As the polarizing film, for example, usable is a film produced by dipping a polyvinyl alcohol film in an iodine solution and stretching it. In case where the polarizing film produced by dipping a polyvinyl alcohol film in an iodine solution and stretching it is used, the surface-treated surface of the transparent cellulose ester film of the invention may be directly stuck to both surfaces of the polarizing film with an adhesive. In the production method of the invention, it is desirable that the cellulose ester film is directly stuck to the polarizing film in the manner as above. As the adhesive, usable is an aqueous solution of polyvinyl alcohol or polyvinyl acetal (e.g., polyvinyl butyral) or a latex of a vinylic polymer (e.g., polybutyl acrylate). Especially preferred as the adhesive is an aqueous solution of a completely-saponified polyvinyl alcohol.

In general, in a liquid-crystal display device, a liquid-crystal cell is disposed between two polarizing plates. Therefore, the device has four polarizer-protective films. The cellulose ester film of the invention may be used as any of those four polarizer-protective films, but the cellulose ester film of the invention is especially useful as the protective film to be disposed between the polarizing film and the liquid-crystal layer (liquid-crystal cell) in the liquid-crystal display device. As the protective film to be disposed on the side of the polarizing film opposite to the side of the cellulose ester film of the invention, a transparent hard coat layer, an antiglare layer, an antireflection layer or the like may be disposed, and in particular, the film of the invention is favorable as the polarizer-protective film to be disposed as the outermost surface layer on the display panel side of the liquid-crystal display device.

### Liquid-Crystal Display Device:

The cellulose ester film of the invention and the optically-compensatory film and the polarizing plate comprising the film can be used in various display modes of liquid-crystal display devices. Various liquid-crystal modes where the film of the invention can be used are described. Above all, the cellulose ester film of the invention and the optically-compensatory film and the polarizing plate comprising the film are favorably used in VA-mode liquid-crystal display devices. The liquid-crystal display devices may be any of transmission-mode, reflection-mode or semitransmission-mode devices.

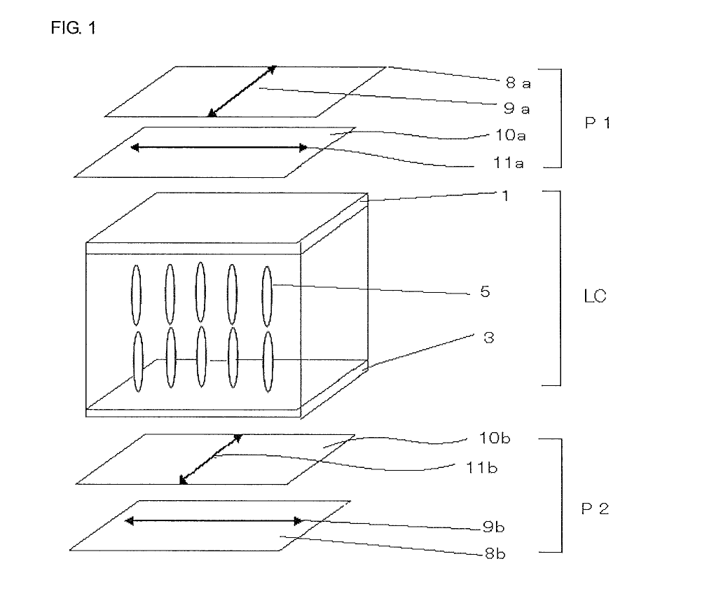

FIG. 1 shows a schematic cross-sectional view of one example of a liquid-crystal display device of the invention. In FIG. 1, the upper side is a viewers' side (panel side), and the lower side is a backlight side.

The VA-mode liquid-crystal display device of in FIG. 1 comprises a liquid-crystal cell LC (comprising an upper substrate 1, a lower substrate 3 and a liquid-crystal layer 5), and a pair of an upper polarizing plate P1 and a lower polarizing plate P2 disposed to sandwich the liquid-crystal cell LC therebetween. In general, polarizing films are incorporated into the liquid-crystal display device as polarizing plates having a protective film on both surfaces thereof; however, in FIG. 1, the outer protective film of the polarizing film is omitted. The polarizing plates P1 and P2 each have a polarizing film 8a and 8b, respectively; and they are so disposed that the absorption axes 9a and 9b thereof are perpendicular to each other. The liquid-crystal cell LC is a VA-mode liquid-crystal cell, and at the time of black level of display, the liquid-crystal layer 5 is in homeotropic alignment as in FIG. 1. The upper substrate 1 and the lower substrate 3 each have an alignment film (not shown) and an electrode layer (not shown) on the inner surface thereof; and the substrate 1 has a color filter layer (not shown) on the viewers' side inner surface thereof.

Between the upper substrate 1 and the upper polarizing film 8a, and between the lower substrate 3 and the lower polarizing film 8b, disposed are retardation films 10a and 10b, respectively. The retardation films 10a and 10b are cellulose ester films of the invention. The retardation films 10a and 10b are so disposed that the in-plane slow axes 11a and 11b thereof could be perpendicular to the absorption axes 9a and 9b of the upper polarizing film 8a and the lower polarizing film 8b, respectively. Specifically, the retardation films 10a and 10b are so disposed that their slow axes are perpendicular to each other. The retardations films 10a and 10b each comprising the cellulose ester film of the invention contribute toward reducing the light leakage and the color shift that may occur in oblique directions at the time of black level of display.

### (Hard Coat Film, Antiglare Film, Antireflection Film)

The cellulose ester film of the invention may be applied to a hard coat film, an antiglare film, or an antireflection film, as the case may be. For the purpose of enhancing the visibility of flat panel displays such as LCD, PDP, CRT, EL and the like, any or all of a hard coat layer, an antiglare layer and an antireflection layer may be given to one or both surfaces of the transparent cellulose ester film of the invention. Preferred embodiments of such antiglare film and antireflection film are described in detail in Hatsumei Kyokai Disclosure Bulletin (No. 2001-1745, published on Mar. 15, 2001 by Hatsumei Kyokai), pp. 54-57, and are favorably applicable to the cellulose ester film of the invention.

### Examples

The characteristic features of the invention are described more concretely with reference to the following Examples and Comparative Examples. In these Examples, the material used, its amount and the ratio, the details of the treatment and the treatment process may be suitably modified or changed not overstepping the sprit and the scope of the invention. Accordingly, the invention should not be limitatively interpreted by the Examples mentioned below.

### 1. Production of Cellulose Ester Film:

100% by mass of a cellulose ester, and as a plasticizer, 6% by mass of TPP (triphenyl phosphate) and 5% by mass of BDP (biphenyldiphenyl phosphate), and further the ingredients shown in the following Table were mixed in the blend ratio shown in the Table, thereby preparing a mixed cellulose ester (concretely, cellulose acetate propionate). The solution was cast, using a band caster, and the resulting web was peeled away from the band, then stretched by 30% in the TD direction (transverse direction, that is, film width direction) at 140° C., and dried to give a cellulose ester film (concretely, a cellulose acetate propionate film) having a thickness of 50 μn. This is a film 101.

Other films 102 to 110 were produced in the same manner as that for the film 101, for which, however, the composition was changed as in the following Table. In addition, films 201 to 204 were produced in which the proportion of the additive was changed as in the following Table.

TABLE 2

| | Cellulose Ester | | | | |
|---|---|---|---|---|---|
| | Degree of | Degree of | Total | Additive | |
| | Substitution | Substitution | Degree of | | Amount *3 |
| Film No. | with Ac *1 | with Pro or Bu *2 | Substitution | Type *4 | (% by mass) |
| 101 | 1.32 | 1.06 (Pro) | 2.38 | — | — |
| 102 | 1.32 | 1.10 (Pro) | 2.42 | — | — |
| 103 | 1.32 | 1.21 (Pro) | 2.53 | — | — |
| 104 | 1.25 | 1.21 (Pro) | 2.46 | — | — |
| 105 | 1.15 | 1.25 (Pro) | 2.40 | — | — |
| 106 | 1.23 | 1.11 (Bu) | 2.34 | — | — |
| 107 | 1.32 | 0.80 (Pro) | 2.12 | — | — |
| 108 | 0.98 | 1.10 (Pro) | 2.08 | — | — |
| 109 | 1.65 | 1.12 (Pro) | 2.77 | — | — |
| 110 | 2.48 | 0.00 (—) | 2.48 | — | — |
| 201 | 1.32 | 1.21 (Pro) | 2.53 | Compound 19 | 2 |
| 202 | 1.32 | 1.21 (Pro) | 2.53 | Compound 20 | 4 |
| | | | | Compound 21 | 2 |
| 203 | 1.25 | 1.21( Pro) | 2.46 | Compound 20 | 4 |
| | | | | Compound 21 | 2 |
| 204 | 1.15 | 1.25 (Pro) | 2.40 | Compound 20 | 4 |
| | | | | Compound 21 | 2 |

*1: Degree of Substitution with acyl (X₁ in formula (I))
*2: Degree of Substitution with propionyl (Pro) or butyryl (Bu) (X₂ in formula (I))
*3. Ratio by mass with respect to the amount of cellulose ester
*4: As follows

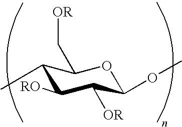

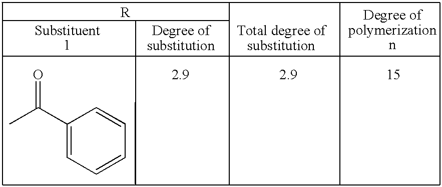

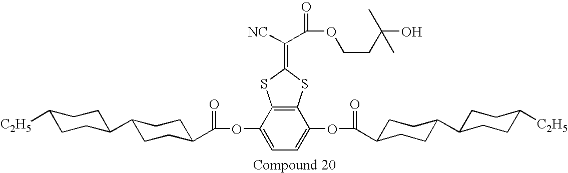

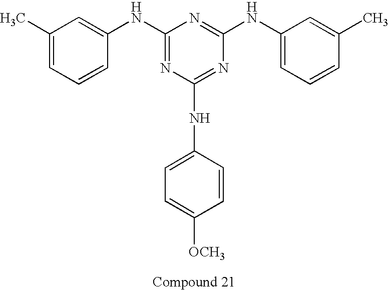

The produced films were analyzed for the characteristics thereof. The results are shown in the following Table.

| | | | Re(650)- | Rth(650)- | | | Axial mis- | |
|---|---|---|---|---|---|---|---|---|
| Film | Re(589) | Rth(589) | Re(450) | Rth(450) | thickness | | alignment | Note |
| No. | nm | nm | nm | nm | μm | Haze % | ° | *1 |
| 101 | 47 | 138 | 6 | 12 | 50 | 0.4 | 0.3 | I |
| 102 | 45 | 133 | 7 | 13 | 50 | 0.4 | 0.3 | I |
| 103 | 42 | 127 | 7 | 14 | 50 | 0.4 | 0.3 | I |
| 104 | 44 | 130 | 7 | 13 | 50 | 0.4 | 0.3 | I |
| 105 | 45 | 132 | 7 | 13 | 50 | 0.4 | 0.3 | I |
| 106 | 44 | 130 | 7 | 12 | 50 | 0.4 | 0.3 | I |
| 107 | 50 | 146 | 5 | 9 | 50 | 0.4 | 0.6 | C |
| 108 | 51 | 148 | 4 | 9 | 50 | 0.4 | 0.6 | C |
| 109 | 35 | 103 | 3 | 6 | 50 | 0.4 | 0.4 | C |
| 110 | 42 | 126 | 4 | 8 | 50 | 0.4 | 0.6 | C |
| 201 | 53 | 128 | 9 | 17 | 50 | 0.4 | 0.2 | I |
| 202 | 55 | 122 | 13 | 23 | 50 | 0.3 | 0.2 | I |
| 203 | 56 | 124 | 12 | 22 | 50 | 0.3 | 0.2 | I |
| 204 | 58 | 126 | 12 | 22 | 50 | 0.3 | 0.2 | I |
| Product | 42 | 124 | 3 | 4 | 41 | 0.6 | — | C |

*1: “I” means an example of the invention, and “C” means a comparable example

From the results in the above Table, it is understood that the cellulose ester films 101 to 106 and 201 to 204 containing a cellulose ester that satisfies the formulae I to III are all examples of the cellulose ester film of the invention satisfying the formulae IV to IX. On the other hand, it is also understood that the films 107 to 110 containing a cellulose ester that does not satisfy at least any one of the formulae I to III all do not satisfy any of the formulae IV to IX, or the axial misalignment in these films is great.

For comparison and for confirming the display performance in the liquid-crystal display device mentioned below, the characteristics of the optical film actually incorporated in a commercially available LCD television. This film was peeled away from the LCD television as the polarizing plate thereof, and the optical film was separated from it by dissolving the polarizing element in hot water. Thus separated, the film was analyzed in the same manner as in Examples, and its data are shown in the Table.

### 2. Production of Polarizing Plate:

The surfaces of the cellulose ester film 103 and 203 of the invention, and the comparative film 110 thus produced in the manner as above were saponified with alkali. Concretely, the film was dipped in an aqueous 1.5 N sodium hydroxide solution at 55° C. for 2 minutes, then washed in a water-washing bath at room temperature, and neutralized with 0.1 N sulfuric acid at 30° C. Again this was washed in a water-washing bath at room temperature, and dried with hot air at 100° C.

Similarly, a film of Fujitac TD80UL (by FUJIFILM) was saponified with alkali. Separately, a roll of polyvinyl alcohol film having a thickness of 80 μm was unrolled and continuously stretched by 5 times in an aqueous iodine solution and dried to give a polarizing film having a thickness of 20 μm.

The polarizing film was sandwiched between any of the above-mentioned, alkali-saponified polymer films 103, 203, comparative film 110 and a film of Fujitac TD80UL (by FUJIFILM) that had been alkali-saponified in the same manner as above, in such a manner that the saponified surfaces of those films could face the polarizing film, and these were stuck together with an aqueous 3% polyvinyl alcohol (Kuraray's PVA-117H) serving as an adhesive, thereby constructing polarizers 103, 203 and 110 in which any of the films 103, 203 and 110 and the film TD80UL are the protective films for the polarizing film.

### 3. Production of Liquid-Crystal Display Device:

Using the polarizers 103, 203 and 110 produced in the above, liquid-crystal display deices Nos. 103, 203 and 110 having the same constitution as in FIG. 1 were constructed. Concretely, a VA-mode liquid-crystal TV (Sony's BRAVIA KDL40J-5000) was used as the liquid-crystal cell, and the polarizers were incorporated as the polarizer on the panel side and as the polarizer on the backlight side (P1 and P2 in FIG. 1), thereby constructing the liquid-crystal display devices. In these, the retardation films were so disposed that their slow axes could be perpendicular to each other as in FIG. 1.

### (Evaluation)

### Transmittance at the Time of Black Level and White Level of Display:

The liquid-crystal display devices Nos. 103, 203 and 110 constructed in the above, and the original commercially available LCD TV (Sony's BRAVIA KDL40J-5000) were tested for the transmittance in the front direction and in the oblique direction (in the direction at a polar axis of 45 degrees and at an azimuth angle of 60 degrees) in the black state and in the white state, thereby calculating the contrast in the front direction (the direction along the normal line relative to the displaying plane) and the contrast in the oblique direction. The data of the contrast in the oblique direction are shown in the following Table.

### Color Shift at the Time of Black Level of Display:

The liquid-crystal display devices Nos. 103, 203 and 110 constructed in the above, and the original commercially available LCD TV (Sony's BRAVIA KDL40J-5000) were tested for the color shift, Δu′v′(−√(u′max−u′min)²+(v′max−v′min)²) in the black sate. In this, u′max (v′max) means the maximum u′ (v′) at a polar angle 45 degrees and in a range of an azimuth angle of from 0 to 360 degrees; and u′min (v′min) means the minimum u′ (v′) in a range of from 0 to 360 degrees. These indicate the level of color shift on color space coordinates where the horizontal axis is u′ and the vertical axis is v′. The results are shown in the following Table.

TABLE

| | Polarizing | Polarizing | | | |
|---|---|---|---|---|---|
| LCD | Plate | Plate | Contrast | Color shift | Note |
| No. | P1 | P2 | *1 | (Δu′v′) | *2 |
| 103 | 103 | 103 | 66 | 0.044 | I |
| 202 | 203 | 203 | 72 | 0.032 | I |
| 110 | 110 | 110 | 54 | 0.088 | C |
| Product | Product | Product | 56 | 0.096 | C |
| TV | | | | | (Product) |

*1: Contrast in the oblique direction defined as a polar angle of 45° and an azimuth angle of 60°
*2: “I” means an example of the invention, and “C” means a comparable example

From the results in the above Table, it is understood that the liquid-crystal display devices Nos. 103 and 203 in which the cellulose ester film of the invention is used as the protective film of the polarizer on the panel side and that on the backlight side (the protective film disposed on the side of the liquid-crystal cell, corresponding to 10a and 10b in FIG. 1) both have a higher contrast in the oblique direction as compared with that of the comparative device No. 110 and the commercially available TV, and that the color shift in the display devices Nos. 103 and 203 of the invention is smaller than that in the comparative device No. 110 and the commercially available TV.

1. A cellulose ester film, comprising at least one cellulose ester that satisfies the following formulae I to III, which satisfies the following formulae IV to VII:
2.2≦X₁+X₂≦2.55, I
1.1≦X₁≦1.5, II
1.05≦X₂≦1.4, III
Re(450)/Re(550)<1, IV
Re(650)/Re(550)>1, V
Rth(450)/Rth(550)<1, VI
Rth(650)/Rth(550)>1, VII
wherein X₁ means a degree of substitution with an acetyl group in the cellulose ester; X₂ means a degree of substitution with a propionyl group and/or a butyryl group in the cellulose ester; Re(λ) means retardation (nm) in plane of the film at a wavelength of λ (nm); and Rth(λ) means retardation (nm) along the thickness direction of the film at a wavelength of λ (nm).

2. The cellulose ester film of claim 1, wherein said at least one cellulose ester satisfies the following formulae I′ to III′, and the film satisfies the following formulae VIII and IX:
2.3≦X₁+X₂≦2.5, I′
1.2≦X₁≦1.4, II′
1.1≦X₂≦1.3. III′
5 nm≦{Re(650)−Re(450)}≦20 nm, VIII
10 nm≦{Rth(650)−Rth(450)}≦30 nm. IX

3. The cellulose ester film of claim 1, which satisfies the following formulae X and XI:
40 nm≦Re(589)≦70 nm, X
90 nm≦Rth(589)≦220 nm. XI

4. The cellulose ester film of claim 1, comprising a compound in an amount of from 0.1 to 30% by mass with respect to the amount of the cellulose ester, wherein the polarizability anisotropy in the direction of the short axis of each molecule of the compound is larger than that in the direction of the long axis; and
each molecule of the compound aligns so that its long axis is along the main chain of the cellulose ester in a cellulose ester film.

5. The cellulose ester film of claim 1, wherein the compound is a compound represented by formula (1): 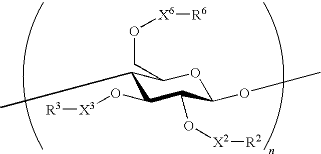
where R², R³ and R⁶ each independently represent a hydrogen atom, aliphatic group or aromatic group; X², X³ and X⁶ each independently represent a single bond or a divalent linking group selected from the group consisting of —O—, —CO—, —NR— (where R represents an aliphatic or aromatic group) and any combinations thereof; and n is a natural number of from 6 to 50.

6. The cellulose ester film of claim 1, wherein the compound is a compound represented by formula (A): 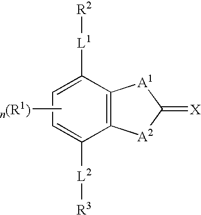
where L¹ and L² each independently represent a single bond or a divalent linking group; A¹ and A² each independently represent a group selected from the group consisting of —O—, —NR— where R represents a hydrogen atom or a substituent, —S— and —CO—; R¹, R² and R³ independently represent a substituent; X represents a nonmetal atom selected from the groups 14-16 atoms, provided that X may bind with at least one hydrogen atom or substituent; and n is an integer from 0 to 2.

7. The cellulose ester film of claim 1, of which haze is equal to or less than 0.5%.

8. The cellulose ester film of claim 1, wherein the axial misalignment of the slow axis is equal to or less than 0.4 degrees in the overall width of the film.

9. The cellulose ester film of claim 1, which has a thickness of from 20 to 80 μm.

10. A polarizing plate comprising a cellulose ester film of claim 1.

11. A liquid-crystal display device comprising a polarizing plate of claim 10.

12. The liquid-crystal display device of claim 11, wherein each one polarizing plate of claim 10 is disposed on both the panel side and the backlight side of a VA-mode liquid-crystal so that the absorption axes of the polarizing plates are perpendicular to each other.
